(19) United States
(12) Patent Application Publication
(10) Pub. No.: US 2010/0322349 A1
(43) Pub. Date: Dec. 23, 2010

(54) METHOD FOR TRANSMITTING DATA USING CYCLIC DELAY DIVERSITY

(76) Inventors: Moon Il Lee, Anyang-si (KR); Bin Chul Ihm, Anyang-si (KR); Wook Bong Lee, Anyang-si (KR); Hyun Soo Ko, Anyang-si (KR); Jae Won Chang, Anyang-si (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/446,565

(22) PCT Filed: Oct. 23, 2007
(86) PCT No.: PCT/KR07/05206

§ 371 Date: Apr. 21, 2009

Related U.S. Application Data
(60) Provisional application No. 60/862,566, filed on Oct. 23, 2006.
(60) Provisional application No. 60/940,593, filed on May 29, 2007.

(30) Foreign Application Priority Data
Apr. 10, 2007 (KR) 10-2007-0034994
Jul. 11, 2007 (KR) 10-2007-0069770

(51) Int. Cl. H04L 27/00

(52) U.S. Cl. 375/299; 375/295

(57) ABSTRACT

A method of transmitting data using cyclic delay in a multi-antenna system using a plurality of subcarriers is disclosed. Data is transmitted through a phase shift based precoding scheme enhanced from a related art phase shift diversity and a related art precoding scheme. A generalized cyclic delay diversity scheme is selectively applied to a phase shift based precoding scheme or a related art precoding scheme executed on a frequency domain is transferred to a time domain to be applied as a generalized cyclic delay diversity scheme. Accordingly, complexity of a receiver is reduced and communication efficiency can be enhanced.

### TECHNICAL FIELD

The present invention relates to a method of transmitting signal in MIMO (multiple-input multiple-output)-OFDM (orthogonal frequency division multiplexing) system.

### BACKGROUND ART

Recently, the demand for a wireless communication service has rapidly risen owing to the generalization of information communication services, the advent of various multimedia services, and the appearance of high-quality services. To actively cope with the demand, a size of a communication system should be raised in the first place. In order to raise a communication size in a wireless communication environment, it is able to consider a method of finding a new available frequency band or a method of raising efficiency for limited resources. For the latter method, a spatial domain for resource utilization is additionally secured to obtain a diversity gain in a manner of providing a plurality of antennas to a transmitter and receiver or a transmission size of capacity is raised in a manner of transmitting data in parallel through each antenna. Such a technology is called a multi-antenna transmitting/receiving technique to which many efforts have been actively made to research and develop.

In the multi-antenna transmitting/receiving technique, a general structure of a multiple-input multiple-output (MIMO) system using OFDM (orthogonal frequency division multiplexing) is explained with reference to FIG. 1 as follows.

In a transmitting end, a channel encoder 101 reduces influence caused by channel or noise in a manner of attaching a redundant bit to a transmission data bit. A mapper 103 transforms data bit information into data symbol information. A serial-to-parallel converter 105 parallelizes a data symbol to carry on a plurality of subcarriers. A multi-antenna encoder 107 transforms a parallelized data symbol into a spatiotemporal signal.

In a receiving end, a multi-antenna decoder 109, a parallel-to-serial converter 111, a demapper 113 and a channel decoder 115 plays functions reverse to those of the multi-antenna encoder 107, the serial-to-parallel converter 105, the mapper 103 and the channel encoder 101 in the transmitting end, respectively.

Various techniques are required for a MIMO-OFDM system to enhance data transmission reliability. As a scheme for increasing a spatial diversity gain, there is space-time code (STC), cyclic delay diversity (CDD) or the like. As a scheme for increasing a signal to noise ratio (SNR), there is beamforming (BF), precoding or the like. In this case, the space-time code or the cyclic delay diversity scheme is normally employed to provide robustness for an open-loop system in which feedback information is not available at the transmitting end due to fast time update of the channel. In other hand, the beamforming or the precoding is normally employed in a closed-loop system in order to maximize a signal to noise ratio by using feedback information which includes a spatial channel property.

As a scheme for increasing a spatial diversity gain and a scheme for increasing a signal to noise ratio among the above-mentioned schemes, cyclic delay diversity and precoding are explained in detail as follows.

First of all, in the cyclic delay scheme, a receiving end obtains a frequency diversity gain in a manner that every antenna transmits a signal differing in delay or size in transmitting an OFDM signal in a system provided with a plurality of transmitting antennas. FIG. 2 shows a configuration of a multi-antenna transmitter using a cyclic diversity scheme.

OFDM symbol is transmitted through each antennas and different value of cyclic delay is applied across the transmit antennas. A cyclic prefix (CP) is attached thereto to prevent inter-channel interference. The corresponding signal is then transmitted to a receiving end. In doing so, a data sequence delivered from a first antenna is intactly transmitted to the receiving end. Yet, data sequences delivered from the other antennas are transmitted in a manner of being cyclically delayed by predetermined bits rather than a previous antenna.

Meanwhile, if the cyclic delay diversity scheme is implemented on a frequency domain, the cyclic delay can be represented as a multiplication of a phase sequence. In particular, referring to FIG. 3, each data sequence on a frequency domain is multiplied by a prescribed phase sequence (phase sequence 1˜phase sequence M) set different for each antenna, fast inverse Fourier transform (IFFT) is performed thereon, and a corresponding result is then transmitted to a receiving end. This is called a phase shift diversity scheme.

The phase shift diversity scheme can artificially introduce frequency selectivity into a flat fading channel by increasing delay spread of the channel at the receiving end. Thereby, a frequency diversity gain or a frequency scheduling gain can be obtained.

The precoding scheme includes a codebook based precoding scheme used for a case that feedback information is finite in a closed loop system or a scheme for quantizing to feed back channel information. The codebook based precoding is a scheme for obtaining a signal to noise ratio (SNR) gain in a manner of feeding back a precoding matrix index already known to transmitting and receiving ends to the transmitting end.

FIG. 4 is a block diagram of transmitting and receiving ends of a multi-antenna system using the codebook based precoding according to a related art.

Referring to FIG. 4, each of transmitting and receiving ends has predefined finite precoding matrixes (P₁˜P_{L}). The receiving end feeds back a preferred or optimal precoding matrix index (1) to the transmitting end using channel information. The transmitting end applies a precoding matrix corresponding to the fed-back index to transmission data (x₁˜X_{Mt}). For reference, Table 1 exemplarily shows a codebook applicable to a case that 3-bit feedback information is used by IEEE 802.16e system supporting a spatial multiplexing rate 2 with two transmitting antennas.

TABLE 1

| Matrix | | |
|---|---|---|
| Index | | |
| (binary) | Column 1 | Column 2 |
| 000 | 1 | 0 |
| | 0 | 1 |
| 001 | 0.7940 | −0.5801 − j0.1818 |
| | −0.5801 + j0.1818 | −0.7940 |
| 010 | 0.7940 | 0.0579 − j0.6051 |
| | 0.0579 + j0.6051 | −0.7940 |
| 011 | 0.7941 | −0.2978 + j0.5298 |
| | −0.2978 − j0.5298 | −0.7941 |
| 100 | 0.7941 | 0.6038 − j0.0689 |
| | 0.6038 + j0.0689 | −0.7941 |
| 101 | 0.3289 | 0.6614 − j0.6740 |
| | 0.6614 + j0.6740 | −0.3289 |
| 110 | 0.5112 | 0.4754 + j0.7160 |
| | 0.4754 − j0.7160 | −0.5112 |
| 111 | 0.3289 | −0.8779 + j0.3481 |
| | −0.8779 − j0.3481 | −0.3289 |

### DISCLOSURE OF THE INVENTION

### Technical Problem

The above-explained phase shift diversity scheme is also advantageous in obtaining a frequency selectivity diversity gain in an open loop and a frequency scheduling gain in a closed loop. Therefore, the phase shift diversity scheme has been studied and investigated so far. However, the conventional phase shift diversity scheme restricts the spatial multiplexing rate as 1, thus maximum data rate is also restricted. In case that resource allocation is carried out fixedly, it is difficult to obtain the above gains.

Since the above-explained codebook based precoding scheme is able to use a high spatial multiplexing rate by requiring small-size feedback information (index information), it is advantageous in enabling effective data transmission.

However, a stable channel should be secured for feedback. So, it is not suitable for a mobile environment having considerable channel variations. And, it is applicable to a closed loop system only.

### Technical Solution

Accordingly, the present invention is directed to a method of transmitting data using cyclic delay in a multi-antenna system using a plurality of subcarriers that substantially obviates one or more of the problems due to limitations and disadvantages of the related art.

An object of the present invention is to provide a generalized phase shift based precoding scheme which can be used irrespective of the antenna configuration and spatial multiplexing rate, while keeping the advantages of the related art cyclic delay diversity, phase shift diversity and precoding scheme.

Another object of the present invention is to provide an enhanced phase shift based precoding scheme or an enhanced cyclic delay diversity scheme in a manner of selectively adding time-variable phase shift diversity, time-variable cyclic delay diversity and the like to the aforesaid phase shift based precoding scheme.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of transmitting (orthogonal frequency division multiplexing) system, according to the present invention includes the steps of spatial processing a OFDM symbol corresponding to each of the subcarriers on a frequency domain with considering time variable element, transforming the spatial processed OFDM symbol into a transmission signal on a time domain, and transforming the spatial processed OFDM symbol into a transmission signal on a time domain.

Preferably, in the embodiment of the present invention, the method may further include at least one of adding a first pilot symbol corresponding to each antenna to the spatial-processed OFDM signal, multiplying the transmission signal by a plurality of per-antenna weight and applying a prescribed cyclic delay to the transmission signal.

To further achieve these and other advantages and in accordance with the purpose of the present invention, a method of transmitting signal in MIMO (multiple-input multiple-output)-OFDM (orthogonal frequency division multiplexing) system, according to the present invention includes the steps of performing precoding on OFDM symbols respectively corresponding to a plurality of the subcarriers on a frequency domain, transforming the precoded OFDM symbols into per-antenna signals on a time domain, applying a prescribed cyclic delay to each of the per-antenna signals, and transmitting the per-antenna signals.

Preferably, in the embodiment of the present invention, the method may further include at least one of adding a first pilot symbol corresponding to each antenna to each of the precoded OFDM symbols and adding a second pilot symbol transformed into the time domain to each of the cyclic-delayed per-antenna signals.

To further achieve these and other advantages and in accordance with the purpose of the present invention, a method of transmitting signal in MIMO (multiple-input multiple-output)-OFDM (orthogonal frequency division multiplexing) system, according to the present invention includes the steps of determining a phase shift based precoding matrix by multiplying a first matrix for a phase shift by a second matrix for transforming the first matrix into a unitary matrix, phase shift based precoding by multiplying OFDM symbols by the determined phase shift based precoding matrix corresponding to each of a plurality of the subcarriers, transforming the phase shift based precoded OFDM symbols into transmission signals on a time domain, applying a prescribed cyclic delay to each of the transmission signals, and transmitting the cyclic delayed transmission signals.

Preferably, in the embodiment of the present invention, the method may further include at least one of multiplying each of the transmission signals by a plurality of per-antenna weight, adding a first pilot symbol corresponding to each antenna to each of the phase shift based precoded OFDM signals, and adding a second pilot symbol transformed into the time domain to each of the cyclic-delayed transmission signals.

And the phase shift based precoding matrix may be represented as

$$[ \begin{matrix}{e}^{{jθ}_{1} ( t ) k} & 0 & 0 & 0 \\ 0 & {e}^{{jθ}_{2} ( t ) k} & 0 & 0 \\ 0 & 0 & ⋱ & 0 \\ 0 & 0 & 0 & {e}^{{jθ}_{{N}_{t}} ( t ) k}\end{matrix} ] ( {U}_{{N}_{t} \times R} ( t ) )$$

and wherein a phase angle θᵢ(t) (i=1, . . . , Nₜ) of the first matrix or the second matrix is a time variable element.

To further achieve these and other advantages and in accordance with the purpose of the present invention, in a multi-antenna system, a method of transmitting signal according to the present invention includes the steps of performing spatial processing associated with multi-antennas on each data stream to be transmitted via at least one of the multi-antennas, performing a transmission power allocation precoding on the spatial processed data stream to control transmission power for the multi-antennas, transforming the transmission power allocation precoded data stream into a per-antenna signal on a time domain, and transmitting the per-antenna signal via at least one of the multi-antennas.

Preferably, in the embodiment of the present invention, the method may further include at least one of applying phase shift diversity on the each the spatial processed data stream, and applying cyclic delay diversity on the per-antenna signal.

And the phase shift diversity may apply a large cyclic delay value and wherein the cyclic delay diversity may apply a small cyclic delay value.

And the method may further include at least one of adding a first pilot symbol to the spatial processed data stream, adding a second pilot symbol to the transmission power allocation precoded data stream, and adding a third pilot symbol transformed into the time domain to the per-antenna signal.

And the transmission power allocation precoding may be executed by multiplying a Nₜ×Nₜ unitary matrix (Nₜ is a number of the multi-antennas). And the Nₜ×Nₜ unitary matrix may be multiplied by a diagonal matrix with a phase value as a variable. And at least one of the Nₜ×Nₜ unitary and the diagonal matrix may be a time variable element.

It is to be understood that both the foregoing general description and the following detailed description are exemplary and explanatory and are intended to provide further explanation of the invention as claimed.

### ADVANTAGEOUS EFFECTS

Accordingly, the present invention provides the following effects or advantages.

First of all, a phase shift based precoding scheme of the present invention is able to adaptively cope with a channel status or a system status regardless of an antenna configuration or a spatial multiplexing rate while maintaining the advantages provided by the related art phase shift diversity or precoding scheme.

Secondly, by selectively adopting time-dependent phase variation and cyclic delay scheme and the like to a phase shift based precoding scheme, complexity of a transmitter/receiver is enhanced and combination with every multi-antenna scheme is available.

Thirdly, the present invention is applicable by varying a communication condition per a user, thereby obtaining optimal communication performance.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of an orthogonal frequency division multiplexing system having multiple transmitting and receiving antennas;

FIG. 2 is a block diagram of a transmitting end of a multi-antenna system using a cyclic delay diversity scheme;

FIG. 3 is a block diagram of a transmitting end of a multi-antenna system using a phase shift diversity scheme;

FIG. 4 is a block diagram of transmitting and receiving ends of a multi-antenna system using a precoding scheme;

FIG. 5 is a block diagram of a transmitter and receiver for performing phase shift based precoding;

FIG. 6 is a block diagram for a case that a spatial multiplexing scheme and a cyclic delay diversity scheme are applied to a multi-antenna system having four transmitting antennas with a spatial multiplexing rate 2;

FIG. 7 is a diagram for a case that a phase shift based precoding matrix is applied to the multi-antenna system shown in FIG. 6;

FIG. 8 is a diagram for a reconfiguration method of a phase shift based precoding matrix;

FIG. 9 is a diagram for graphs of two kinds of applications of phase shift based precoding and phase shift diversity;

FIG. 10 is a conceptional diagram of a transmitter and receiver supporting GCDD scheme according to an embodiment of the present invention;

FIG. 11 is a conceptional diagram of a transmitter and receiver supporting a modification of GCDD scheme according to an embodiment of the present invention;

FIG. 12 is a conceptional diagram of a transmitter and receiver applied with a combination of GPSD scheme and GCDD scheme according to an embodiment of the present invention;

FIG. 13 is a conceptional diagram of a transmitter and receiver for a case that a combination of GPSD scheme and GCDD scheme is modified according to an embodiment of the present invention;

FIG. 14 is a diagram for a case that a pilot symbol is applied to GPSD scheme executed prior to IFFT according to an embodiment of the present invention;

FIG. 15 is a diagram for representing a GPSD scheme applied part shown in FIG. 12 as a formula according to an embodiment of the present invention;

FIG. 16 is a diagram for a case that a pilot symbol is applied after cyclic delay diversity according to an embodiment of the present invention;

FIG. 17 is a diagram for representing a GPSD scheme applied part shown in FIG. 16 as a formula according to an embodiment of the present invention;

FIG. 18 is a diagram for a case that pilot symbol applying methods shown in FIG. 14 and FIG. 16 are simultaneously applied according to an embodiment of the present invention;

FIG. 19 is a graph of a simulation test result for a GCDD system and a related art system on ITU pedestrian-A channel;

FIG. 20 is a graph of a simulation test result in Typical urban (6-ray) environment;

FIG. 21 is an exemplary block diagram of a transmitter and receiver for applying a transmission power allocation precoding matrix according to an embodiment of the present invention;

FIG. 22 is an exemplary block diagram of a transmitter and receiver for applying a transmission power allocation precoding matrix according to an embodiment of the present invention;

FIG. 23 is an exemplary block diagram of a transmitter and receiver for applying a transmission power allocation precoding matrix according to an embodiment of the present invention;

FIG. 24 is an exemplary block diagram of a transmitter and receiver for applying a pilot symbol to the embodiment shown in FIG. 21 or FIG. 23 according to an embodiment of the present invention;

FIG. 25 is an exemplary block diagram of a transmitter and receiver for applying a pilot symbol to the embodiment shown in FIG. 22 according to an embodiment of the present invention;

FIG. 26 is an exemplary block diagram of a transmitter and receiver for applying a pilot symbol to the embodiment shown in FIG. 21 or FIG. 23 according to an embodiment of the present invention;

FIG. 27 is an exemplary block diagram of a transmitter and receiver for applying a pilot symbol to the embodiment shown in FIG. 23 according to an embodiment of the present invention; and

FIG. 28 is an exemplary block diagram of a transmitter and receiver for applying a pilot symbol to the embodiment shown in FIG. 21 or FIG. 23 according to an embodiment of the present invention.

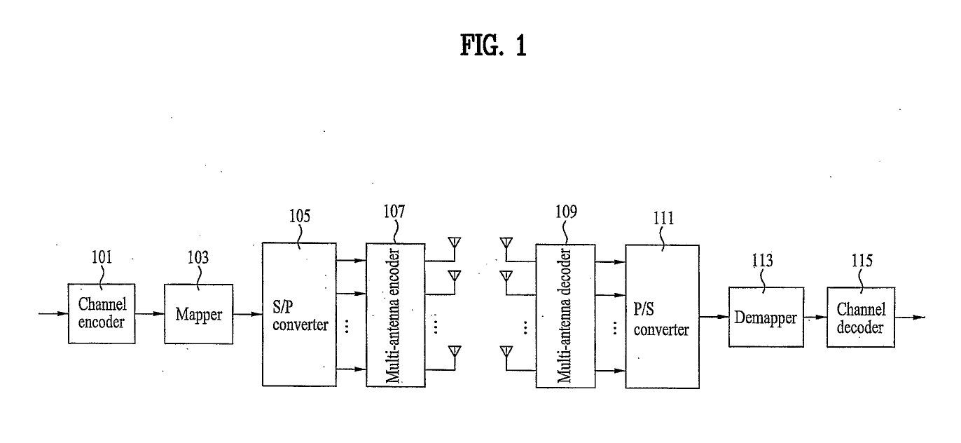

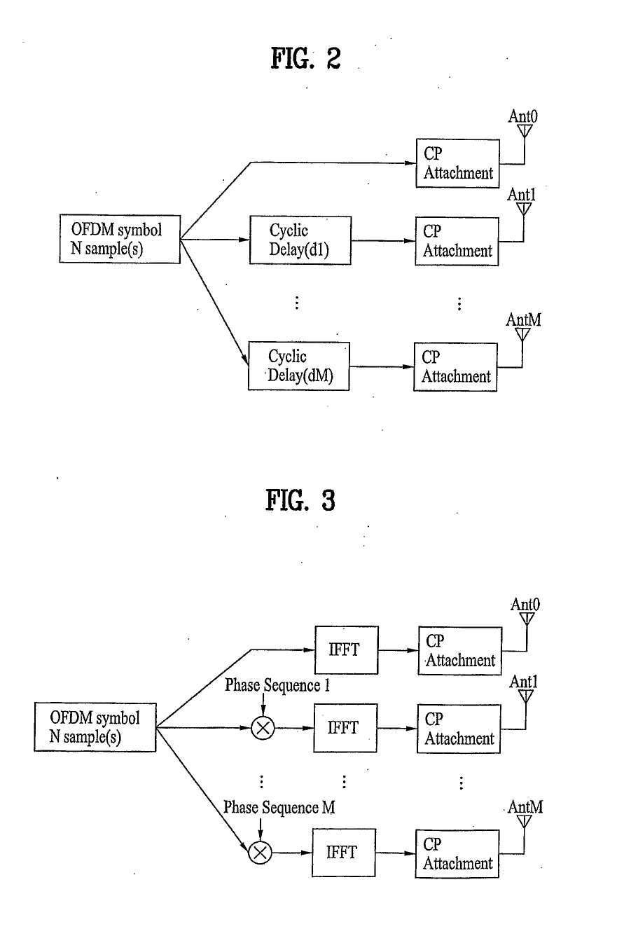

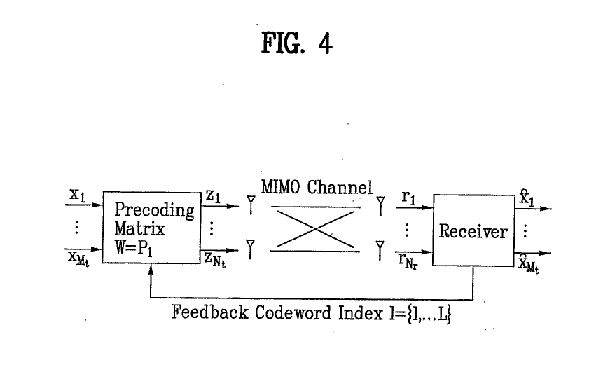

### BEST MODE

### Mode for Invention

Reference will now be made in detail to the preferred embodiments of the present invention, examples of which are illustrated in the accompanying drawings.

### First Embodiment

### Phase Shift Based Precoding

Generation of Phase Shift Based Precoding Matrix

A phase shift based precoding matrix (P) can be represented as follows.

$${p}_{{N}_{t} \times R}^{k} = ( \begin{matrix}{w}_{1 , 1}^{k} & {w}_{1 , 2}^{k} & … & {w}_{1 , R}^{k} \\ {w}_{2 , 1}^{k} & {w}_{2 , 2}^{k} & … & {w}_{2 , R}^{k} \\ ⋮ & ⋮ & ⋱ & ⋮ \\ {w}_{{N}_{t} , 1}^{k} & {w}_{{N}_{t} , 2}^{k} & … & {w}_{{N}_{t} , R}^{k}\end{matrix} ) \qquad [ Formula 1 ]$$

In Formula 1, w_{i,j}^{k} (i=1, . . . , Nₜ, j=1, . . . , R) indicates a complex weight determined by a subcarrier index or a specific frequency band index k, ‘Nₜ’ indicates a number of transmitting antennas, and ‘R’ indicates a spatial multiplexing rate. In this case, the transmitting antenna can include a physical transmitting antenna or a virtual transmitting antenna. If the transmitting antenna includes the virtual antenna, Nₜ is equal to R.

The complex weight can have a value varying in accordance with an OFDM symbol by which an antenna is multiplied and an index or a corresponding subcarrier. And, the complex weight can be determined in accordance with at least one of a channel status and a presence or non-presence of feedback information.

Meanwhile, the phase shift based precoding matrix (P) shown in Formula 1 is preferably designed into a unitary matrix to reduce loss of a channel capacity in a multi-antenna system. In this case, a channel capacity of multi-antenna open loop system is represented as the following formula to look into a condition for the unitary matrix configuration.

$${C}_{u} ( H ) = {log}_{2} ( det ( {I}_{{N}_{r}} + \frac{SNR}{{N}_{t}} {HH}^{H} ) ) \qquad [ Formula 2 ]$$

In Formula 2, ‘H’ indicates an Nᵣ×Nₜ multi-antenna channel matrix, ‘Nₜ’ indicates a number of transmitting antennas, and ‘Nᵣ’ indicates a number of receiving antennas. A result from applying the phase shift based precoding matrix P to Formula 2 is shown in Formula 3.

$${C}_{precoding} = {log}_{2} ( det ( {I}_{{N}_{r}} + \frac{SNR}{{N}_{t}} {HPP}^{H} {H}^{H} ) ) \qquad [ Formula 3 ]$$

In Formula 3, since PP^{H} should be an identity matrix to prevent a loss of a channel capacity, the phase shift based precoding matrix P should correspond to a unitary matrix that satisfies the following conditions.

PP^{H}=I_{N} [Formula 4]

In order for the phase shift based precoding matrix P to become a unitary matrix, the following two kinds of conditions, i.e., a power restriction condition and an orthogonality restriction condition. The power restriction is to enable a sum of squared column elements per a column constructing a matrix to be 1. And, the orthogonality restriction is to provide an orthogonal characteristic between columns. The conditions are represented as the following formulas.

$$\begin{matrix}{\vert {w}_{1 , 1}^{k} \vert}^{2} + {\vert {w}_{2 , 1}^{k} \vert}^{2} + ⋯ + {\vert {w}_{{N}_{t} , 1}^{k} \vert}^{2} = 1 , \\ {\vert {w}_{1 , 2}^{k} \vert}^{2} + {\vert {w}_{2 , 2}^{k} \vert}^{2} + ⋯ + {\vert {w}_{{N}_{t} , 2}^{k} \vert}^{2} = 1 , \\ ⋮ \\ {\vert {w}_{1 , R}^{k} \vert}^{2} + {\vert {w}_{2 , R}^{k} \vert}^{2} + ⋯ + {\vert {w}_{{N}_{t} , R}^{k} \vert}^{2} = 1 & [ Formula 5 ] \\ {w}_{1 , 1}^{k *} {w}_{1 , 2}^{k} + {w}_{2 , 1}^{k *} {w}_{2 , 2}^{k} + ⋯ + {w}_{{N}_{t} , 1}^{k *} {w}_{{N}_{t} , 2}^{k} = 0 , \\ {w}_{1 , 1}^{k *} {w}_{1 , 3}^{k} + {w}_{2 , 1}^{k *} {w}_{2 , 3}^{k} + ⋯ + {w}_{{N}_{t} , 1}^{k *} {w}_{{N}_{t} , 3}^{k} = 0 , \\ ⋮ \\ {w}_{1 , 1}^{k *} {w}_{1 , R}^{k} + {w}_{2 , 1}^{k *} {w}_{2 , R}^{k} + ⋯ + {w}_{{N}_{t} , 1}^{k *} {w}_{{N}_{t} , R}^{k} = 0 & [ Formula 6 ]\end{matrix}$$

According to one embodiment of the present invention, a generalized formula of 2×2 phase shift based precoding matrix is proposed. And, formulas to satisfy the above two kinds of conditions are taken into consideration as follows. Formula 7 shows a general formula of a phase shift based precoding matrix having two transmitting antennas with a spatial multiplexing rate 2.

$${P}_{2 \times 2}^{k} = ( \begin{matrix}{α}_{1} {e}^{j k {θ}_{1}} & {β}_{1} {e}^{j k {θ}_{2}} \\ {β}_{2} {e}^{j k {θ}_{3}} & {α}_{2} {e}^{j k {θ}_{4}}\end{matrix} ) \qquad [ Formula 7 ]$$

In Formula 7, αᵢ or βᵢ (i=1, 2) is a real number, θᵢ (i=1, 2, 3, 4) has a phase value, and k indicates a subcarrier index of OFDM symbol. In order to implement the precoding matrix into a unitary matrix, a power restriction condition shown in Formula 8 and an orthogonality restriction condition shown in Formula 9 should be met.

|α₁e^{jkθ}^{₁}|²+|β₂e^{jkθ}^{₃}|²=1, |α₂e^{jkθ}^{₄}|²+|β₁e^{jkθ}^{₂}|²=1 [Formula 8]

(α₁e^{jkθ}^{₁})*β₁e^{jkθ}^{₂}+(β₂e^{jkθ}^{₃})*α₂e^{jkθ}^{₄}=0 [Formula 9]

In this case, a mark ‘*’ indicates a conjugate complex number. One embodiment of 2×2 phase shift based precoding matrix, which satisfies Formulas 7 to 9, is shown as follows.

$${P}_{2 \times 2}^{k} = \frac{1}{\sqrt{2}} ( \begin{matrix}1 & {e}^{j k {θ}_{2}} \\ {e}^{j k {θ}_{3}} & 1\end{matrix} ) \qquad [ Formula 10 ]$$

In Formula 10, the relation shown in Formula 11 exists between θ₂ and θ₃ due to the orthogonality restriction.

kθ₃=−kθ₂+π [Formula 11]

Meanwhile, a precoding matrix can be stored as a codebook in a memory of a transmitting and/or receiving end. And, the codebook can be configured to include various precoding matrixes generated through a finite number of different θ₂ values.

In this case, the θ₂ value can be suitably set in accordance with a channel status and a presence or non-presence of feedback information.

For instance, in case of using feedback information, it is able to obtain a frequency scheduling gain by setting θ₂ small. In case of not using feedback information, it is able to obtain a high frequency diversity gain by setting θ₂ large.

Reconfiguration of Phase Shift Based Precoding Matrix in Accordance with Multiplexing Rate

Meanwhile, even if the phase shift based precoding matrix, as shown in Formula 7, is generated, it may happen that a spatial multiplexing rate is actually set smaller than that for a number of antennas in accordance with a channel status.

In this case, a specific column corresponding to a current spatial multiplexing rate which is reduced spatial multiplexing rate than before is selected from the generated phase shift based precoding matrix and a new phase shift based precoding matrix can be then reconfigured using the selected column. In particular, instead of generating a new precoding matrix applied to a corresponding system each time a spatial multiplexing rate is changed, a precoding matrix is reconfigured by selecting a specific column of a corresponding precoding matrix utilizing an initially generated phase shift based precoding matrix as it is.

For instance, the precoding matrix shown in Formula 10 assumes that a spatial multiplexing rate is 2 in a multi-antenna system having two transmitting antennas. Yet, the spatial multiplexing rate of the system may be reduced into 1 due to a prescribed reason or cause. If so, it is able to reconfigure a precoding matrix having a spatial multiplexing rate 1 by selecting a specific column from the matrix shown in Formula 10. An example of a phase shift based precoding matrix generated from selecting a second column is shown in Formula 12. This has the same format of the related art cyclic delay diversity scheme having two transmitting antennas.

$${P}_{2 \times 1}^{k} = \frac{1}{\sqrt{2}} ( \begin{matrix}{e}^{j k {θ}_{2}} \\ 1\end{matrix} ) \qquad [ Formula 12 ]$$

In Formula 12, a system having two transmitting antennas is taken as an example. Formula 12 is extensibly applicable to a system having four transmitting antennas as well. Precoding can be carried out by selecting a specific column in accordance with a spatial multiplexing rate that varies after the generation of the phase shift based precoding matrix in case of a spatial multiplexing rate 4.

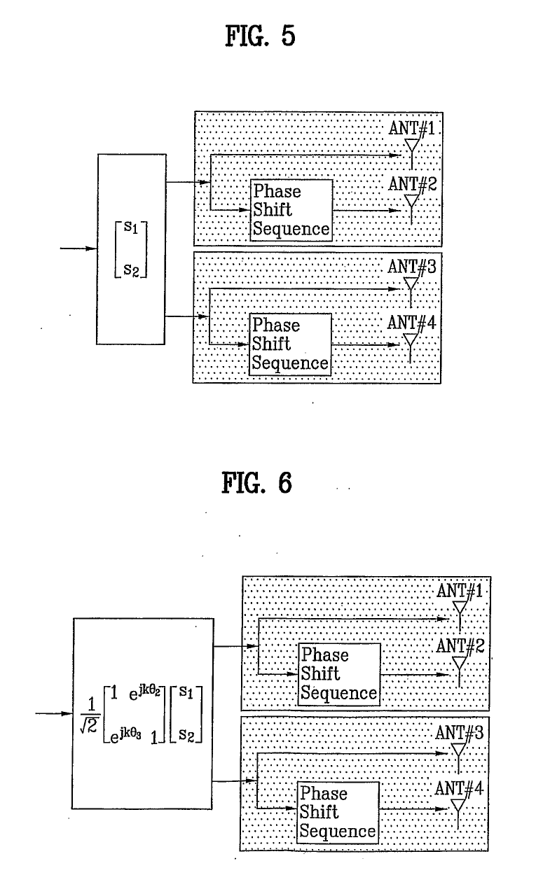

For instance, FIG. 5 shows a case that a related art spatial multiplexing scheme and a related art cyclic delay diversity are applied to a multi-antenna system having four transmitting antennas with a spatial multiplexing rate 2, and FIG. 6 shows a case that the cyclic delay diversity of FIG. 5 is applied to the multi-antenna system together with the phase shift based precoding matrix shown in Formula 10. In FIG. 5 and FIG. 6, cyclic delay diversity is represented as an operation of multiplying a phase shift sequence. And, it is assumed that a phase angle phase shifted by the phase shift sequence is θ₁.

Referring to FIG. 5, a first sequence s₁ and a second sequence s₂ are delivered to a first antenna and a third antenna, respectively. And, a phase shifted first sequence s₁e^{jθ}^{₁} by a prescribed size and a phase shifted second sequence s₂e^{jθ}^{₁} by a prescribed size are delivered to a second antenna and a fourth antenna, respectively. Hence, it can be observed that a spatial multiplexing rate becomes 2 overall.

Referring to FIG. 6, S₁+s₂e^{jkθ}^{₂} is delivered to a first antenna, s₁e^{jkθ}^{₃}+s₂ is delivered to a third antenna, s₁e^{jkθ}^{₁}+s₂e^{jk(θ}^{₁}^{+θ}^{₂}⁾ phase-shifted by a prescribed size is delivered to a second antenna, and s₁e^{jk(θ}^{₁}^{+θ}^{₃}⁾+s₂e^{jkθ}^{₁} phase-shifted by a prescribed size is delivered to a fourth antenna like the second antenna.

Compared to the system shown in FIG. 5, the system shown in FIG. 6, which is capable of performing a cyclic delay (or phase shift) on four antennas using a single precoding matrix, has the advantage of the cyclic delay diversity scheme as well as the advantage of the precoding scheme.

The phase shift based precoding matrix according to the spatial multiplexing rate for each of the 2-antenna system and the 4-antenna system is shown as follows.

TABLE 2

| 2-antenna system | | 4-antenna system | |
|---|---|---|---|
| Spatial | Spatial | Spatial | Spatial |
| multiplexing rate 1 | multiplexing rate 2 | multiplexing rate 1 | multiplexing rate 2 |
| $\frac{1}{\sqrt{2}} ( \begin{matrix}1 \\ {e}^{j {θ}_{1} k}\end{matrix} )$ | $\frac{1}{\sqrt{2}} ( \begin{matrix}1 & - {e}^{- j {θ}_{1} k} \\ {e}^{j {θ}_{1} k} & 1\end{matrix} )$ | $\frac{1}{\sqrt{4}} ( \begin{matrix}1 \\ {e}^{j {θ}_{1} k} \\ {e}^{j {θ}_{2} k} \\ {e}^{j {θ}_{3} k}\end{matrix} )$ | $\frac{1}{\sqrt{4}} ( \begin{matrix}1 & - {e}^{- j {θ}_{1} k} \\ {e}^{j {θ}_{1} k} & 1 \\ {e}^{j {θ}_{2} k} & - {e}^{- j {θ}_{3} k} \\ {e}^{j {θ}_{3} k} & {e}^{- j {θ}_{2} k}\end{matrix} )$ |

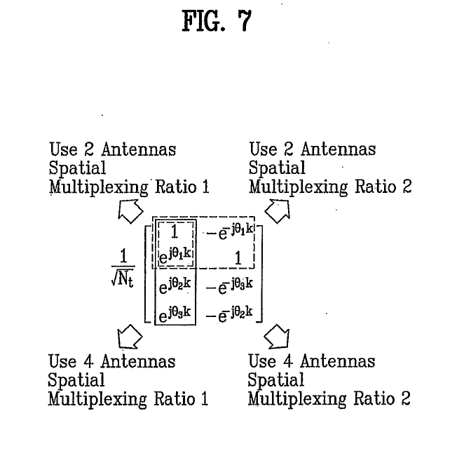

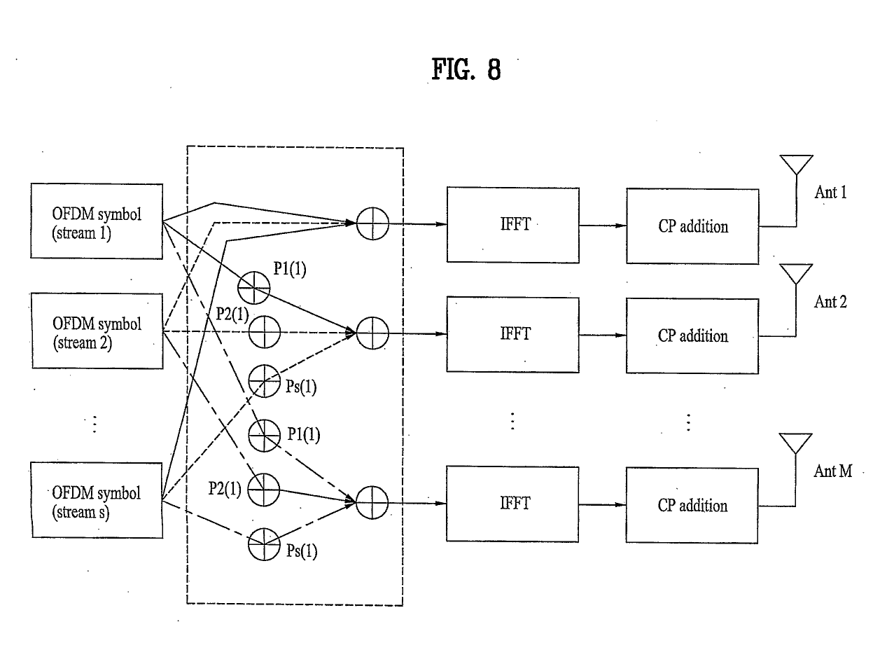

In Table 2, θᵢ (i=1, 2, 3) indicates a phase angle in accordance with a cyclic delay value and k indicates a subcarrier index of OFDM. Each of the precoding matrixes for the above four kinds of cases, as shown in FIG. 7, can be obtained by taking a specific portion of a precoding matrix for a multi-antenna system having four transmitting antennas with a spatial multiplexing rate 2.

Hence, since it is unnecessary to provide the precoding matrixes for the four kinds of the cases to a codebook in addition, memory sizes of transmitting and receiving ends can be saved. Moreover, the above-explained phase shift based precoding matrix can be extended to a system having M antennas with a spatial multiplexing rate N according to the same principle.

### Second Embodiment

### Generalized Phase Shift Diversity

In the former description, a process for configuring a phase shift based precoding matrix in case of four transmitting antennas with a spatial multiplexing rate 2 has been explained.

In the following description, phase shift based precoding is applied to a system having Nₜ transmitting antennas (Nₜ is a natural number equal to or greater than 2) with a spatial multiplexing rate R (R is a natural number equal to or greater than 1).

In the following description, generalized phase shift based precoding scheme could be named as generalized phase shift diversity (hereinafter abbreviated GPSD) scheme.

FIG. 8 is a block diagram of major pats of a transmitter/receiver for performing generalized phase shift diversity.

In a generalized phase shift diversity method, all the streams to be transmitted are transmitted via entire antennas in a manner of multiplying a sequence of a different phase per antenna.

For instance, referring to FIG. 8, an OFDM symbol 1 (stream 1) is transmitted via entire antennas including antennas 1 to M. When the stream 1 is transmitted via the antenna 1, it is transmitted without a phase shift. When the stream 1 is transmitted via the antenna 2, it is transmitted by applying a phase shift by a phase angle P1(1). Thus, phase shifts having different phase angles are applied to the antennas 1 to M to transmit the stream 1.

Likewise, an OFDM symbol 2 (stream 2) is transmitted via entire antennas including antennas 1 to M. When the stream 2 is transmitted via the antenna 1, it is transmitted without a phase shift. When the stream 2 is transmitted via the antenna 2, it is transmitted by applying a phase shift by a phase angle P2(1). Thus, phase shifts having different phase angles are applied to the antennas 1 to M to transmit the stream 1.

Referring to FIG. 8, it can be observed that the rest of the OFDM symbols 3 to S (streams 3 to S) are transmitted in the same manner as explained in the above description.

The generalized phase shift diversity method can be represented as a combination of matrixes shown in Formula 13.

$${P}_{{N}_{t} \times R}^{k} = ( \begin{matrix}{e}^{{jθ}_{1} k} & 0 & … & 0 \\ 0 & {e}^{{jθ}_{2} k} & … & 0 \\ ⋮ & ⋮ & ⋱ & 0 \\ 0 & 0 & … & {e}^{{jθ}_{{N}_{t}} k}\end{matrix} ) {U}_{{N}_{t} \times R} \qquad [ Formula 13 ]$$

In Formula 13, P_{N}_{ₜ}^{k}×R indicates a GPSD matrix for a k^{th} subcarrier of an MIMO-OFDM signal having Nₜ transmitting antennas with a spatial multiplexing rate R. The first matrix at the right of an equal sign ‘=’ is a diagonal matrix for phase shift, and the second matrix at the right of an equal sign ‘=’ is a unitary matrix which spreads data symbols of each codeword in spatial domain and it should satisfy the unitary condition as

$${𝕌}_{{N}_{t} \times R}^{H} \times {𝕌}_{{N}_{t} \times R} = {𝕀}_{R \times R}$$

in order not to hurt open-loop channel capacity. In this case, k indicates a subcarrier index, an index assigned per a unitary resource in accordance with a situation, or index information assigned per a frequency band including at least one subcarrier in accordance with a situation.

The GPSD matrix can be constructed in a manner of multiplying a phase shift matrix (first matrix) enabling a different phase shift angle to be applied per a transmitting antenna by a unitary matrix (second matrix). A GPSD matrix resulting from multiplying a first matrix of diagonal matrix by a second matrix of unitary matrix will satisfy the features of the unitary matrix to be usable as a precoding matrix having capacity lossless property in open-loop scenario.

In Formula 13, a phase angle θᵢ (i=1, . . . , Nₜ) can be obtained from Formula 14 in accordance with a delay value τᵢ(i=1, . . . , Nₜ).

$${θ}_{i} = - 2 π / {N}_{fft} \cdot {τ}_{i} \qquad [ Formula 14 ]$$

In Formula 14, N_{fft} indicates a number of subcarriers of an OFDM signal.

An example of a GPSD matrix in case of using a 1-bit codebook with two transmitting antennas is shown in Formula 15.

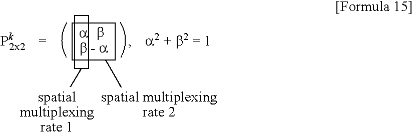

In Formula 15, if a value of α is set, a value of β is easily determined. So, by setting information about the α value to two kinds of appropriate values, it is able to feed back the corresponding information as a feedback index. For instance, agreement between a transmitter and a receiver can be settled in advance in a manner of setting α to 0.2 if a feedback index is 0 or setting α to 0.8 if a feedback index is 1.

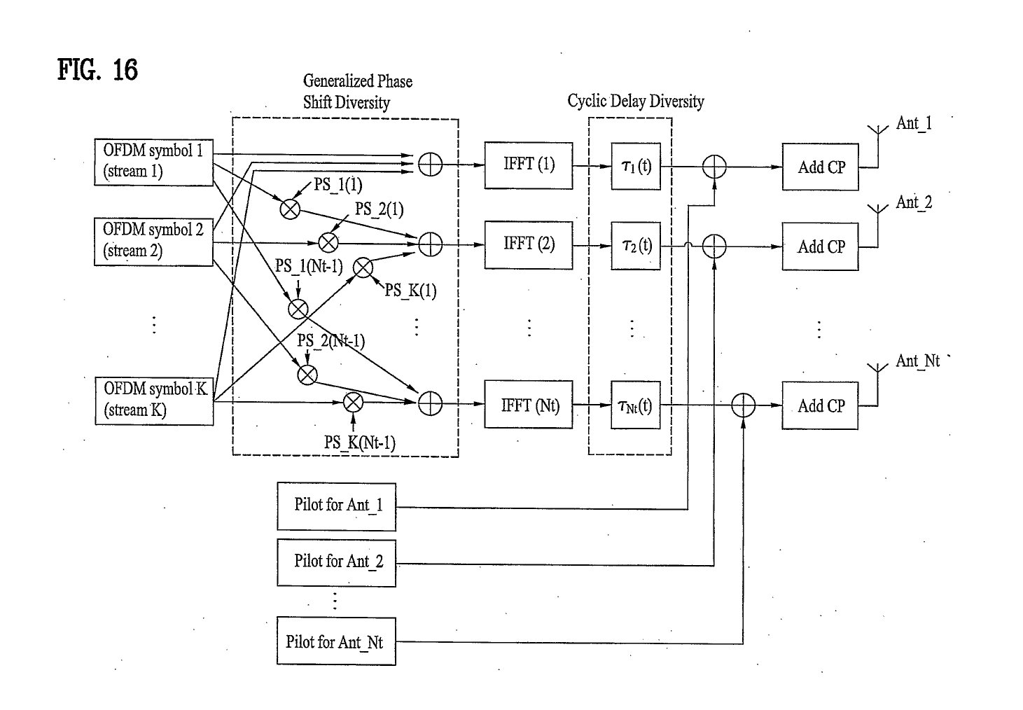

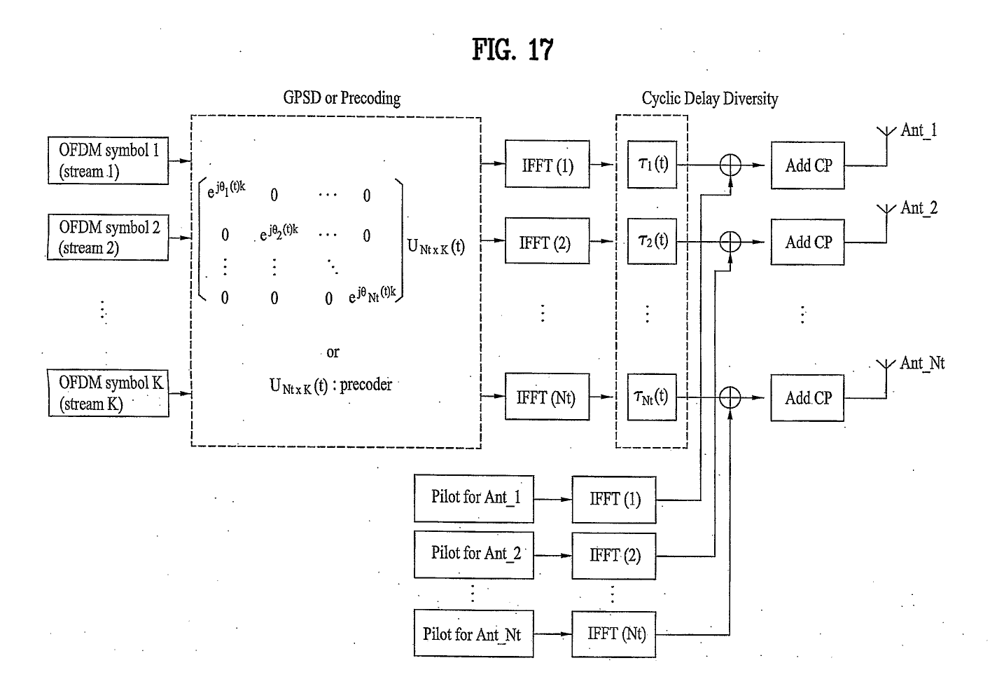

As an example of the second matrix, a matrix having a prescribed feature is usable to obtain a signal to noise ratio (SNR) gain. In particular, in case of using Walsh code as the matrix having the prescribed feature, an example of GPSD matrix is shown in FIG. 16.

$${P}_{4 \times 4}^{k} = \frac{1}{\sqrt{4}} ( \begin{matrix}{e}^{{jθ}_{1} k} & 0 & 0 & 0 \\ 0 & {e}^{{jθ}_{2} k} & 0 & 0 \\ 0 & 0 & {e}^{{jθ}_{3} k} & 0 \\ 0 & 0 & 0 & {e}^{{jθ}_{4} k}\end{matrix} ) ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} ) \qquad [ Formula 16 ]$$

Formula 16 assumes a system having four transmitting antennas with a spatial multiplexing rate 4. In this case, by reconfiguring the second matrix appropriately, it is able to select a specific transmitting antenna (antenna selection) or tune a spatial multiplexing rate (rate tuning).

Formula 17 shows a reconfiguration of the second matrix to select two antennas from the system having four transmitting antennas.

$${P}_{4 \times 4}^{k} = \frac{1}{\sqrt{4}} ( \begin{matrix}{e}^{{jθ}_{1} k} & 0 & 0 & 0 \\ 0 & {e}^{{jθ}_{2} k} & 0 & 0 \\ 0 & 0 & {e}^{{jθ}_{3} k} & 0 \\ 0 & 0 & 0 & {e}^{{jθ}_{4} k}\end{matrix} ) ( \begin{matrix}0 & 0 & 1 & 1 \\ 0 & 0 & 1 & - 1 \\ 1 & 1 & 0 & 0 \\ 1 & - 1 & 0 & 0\end{matrix} ) \qquad [ Formula 17 ]$$

And, Table 3 shows a method of reconfiguring the second matrix to fit a corresponding multiplexing rate in case that a spatial multiplexing rate varies in accordance with a time or a channel status.

TABLE 3

| | |
|---|---|
| ${P}_{4 \times 4}^{k} = \frac{1}{\sqrt{4}} ( \begin{matrix}{e}^{j {θ}_{{1}^{k}}} & 0 & 0 & 0 \\ 0 & {e}^{j {θ}_{{2}^{k}}} & 0 & 0 \\ 0 & 0 & {e}^{j {θ}_{{3}^{k}}} & 0 \\ 0 & 0 & 0 & {e}^{j {θ}_{{4}^{k}}}\end{matrix} )$ | 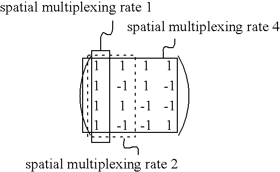 |

In Table 3, a case of selecting a first column from the second matrix, a case of selecting first and second columns from the second matrix, and a case of selecting first to fourth columns from the second matrix are shown in accordance with multiplexing rates, respectively. But the present invention is not limited to such a case. Any combination of the first, second, third and fourth columns may be selected and the number of selected columns are according to the multiplexing rate.

Meanwhile, the second matrix can be provided as a codebook in a transmitting end and a receiving end. In this case, index information for a codebook is fed back to the transmitting end from the receiving end. The transmitting end selects a unitary matrix (the second matrix) of a corresponding index from its codebook and then configures the matrix shown in Formula 13.

Moreover, the second matrix can be periodically modified to enable carrier(s) transmitted for a same timeslot to have a different precoding matrix per a frequency band.

Besides, a phase angle for performing the generalized phase shift diversity (GPSD), i.e., a cyclic delay value is a value preset in a transmitter/receiver or a value delivered to a transmitter by a receiver through feedback. And, a spatial multiplexing rate (R) can be a value present in a transmitter/receiver. Alternatively, a receiver periodically obtains a channel status, calculates a spatial multiplexing rate, and then feeds back the spatial multiplexing rate to a transmitter. Alternatively, a transmitter can calculate and modify a spatial multiplexing rate using channel information fed back by a receiver.

An example of a GPSD matrix using 2×2 and 4×4 Walsh codes as a unitary matrix for obtaining GPSD is summarized as follows.

TABLE 4
2 Tx

| Rate 1 | Rate 2 |
|---|---|
| $\frac{1}{\sqrt{2}} [ \begin{matrix}1 \\ {e}^{j {θ}_{{1}^{k}}}\end{matrix} ]$ | $\frac{1}{\sqrt{2}} [ \begin{matrix}1 & 1 \\ {e}^{j {θ}_{{1}^{k}}} & - {e}^{j {θ}_{{1}^{k}}}\end{matrix} ]$ |

TABLE 5
4 Tx

| Rate 1 | Rate 2 | Rate 4 |
|---|---|---|
| $\frac{1}{2} [ \begin{matrix}1 \\ {e}^{j {θ}_{{1}^{k}}} \\ {e}^{j {θ}_{{2}^{k}}} \\ {e}^{j {θ}_{{3}^{k}}}\end{matrix} ]$ | $\frac{1}{2} [ \begin{matrix}1 & 1 \\ {e}^{j {θ}_{{1}^{k}}} & - {e}^{j {θ}_{{1}^{k}}} \\ {e}^{j {θ}_{{2}^{k}}} & {e}^{j {θ}_{{2}^{k}}} \\ {e}^{j {θ}_{{3}^{k}}} & - {e}^{j {θ}_{{3}^{k}}}\end{matrix} ]$ | $\frac{1}{2} [ \begin{matrix}1 & 1 & 1 & 1 \\ {e}^{j {θ}_{{1}^{k}}} & - {e}^{j {θ}_{{1}^{k}}} & {e}^{j {θ}_{{1}^{k}}} & - {e}^{j {θ}_{{1}^{k}}} \\ {e}^{j {θ}_{{2}^{k}}} & {e}^{j {θ}_{{2}^{k}}} & - {e}^{j {θ}_{{2}^{k}}} & - {e}^{j {θ}_{{2}^{k}}} \\ {e}^{j {θ}_{{3}^{k}}} & - {e}^{j {θ}_{{3}^{k}}} & - {e}^{j {θ}_{{3}^{k}}} & {e}^{j {θ}_{{3}^{k}}}\end{matrix} ]$ |

By the above-explained phase shift based precoding or generalized phase shift diversity according to the first/second embodiment of the present invention, a flat fading channel can be converted to a frequency selectivity channel and a frequency diversity gain or a frequency scheduling gain can be obtained in accordance with a size of a delay sample.

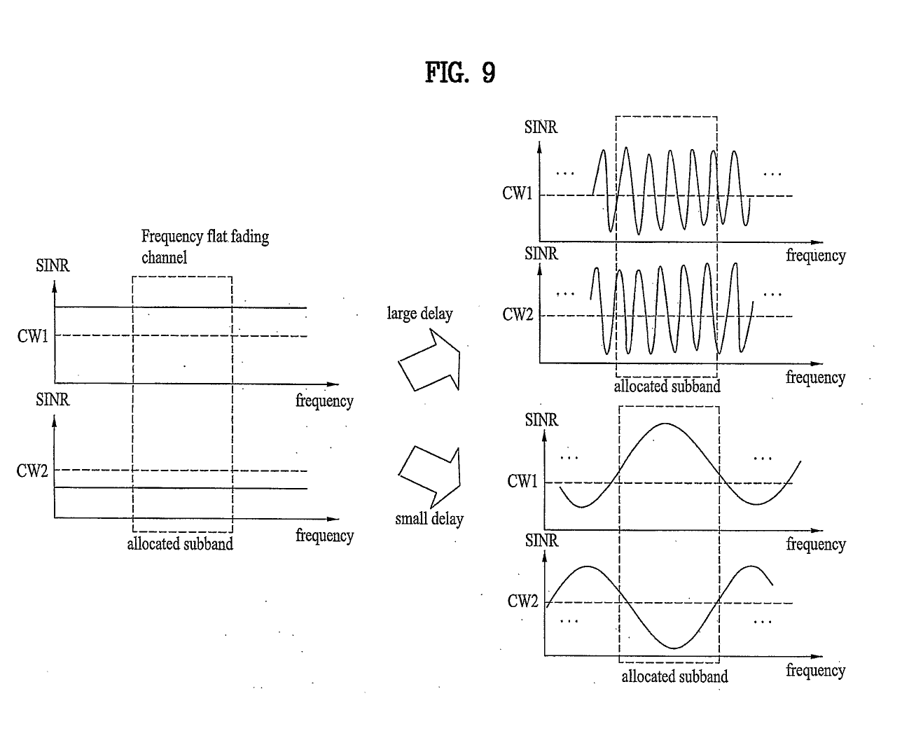

FIG. 9 is a diagram for graphs of two kinds of applications of phase shift based precoding (or phase shift diversity) scheme.

Referring to a right upper part of FIG. 9, in case of using a cyclic delay (or a delay sample) having a large value, a frequency selectivity cycle is increased. Hence, frequency selectivity is raised and a channel code can obtain a frequency diversity gain eventually.

Even if a SNR of a flat fading channel situation is lower than a required SNR for reliable transmission/reception, more robust signal transmission can be provided by increasing frequency selectivity with large delay sampled cyclic delay diversity due to its frequency diversity gain. Hence, it is advantageous that a transmission/reception reliability is significantly increased without channel information. This could be employed for an open loop system in which channel information is not available at the transmitter due to fast time update of the channel.

Referring to a right lower part of FIG. 9, in case of using a cyclic delay (or a delay sample) having a small value, a frequency selectivity cycle is slightly increased. So, a closed loop system uses it to obtain a frequency scheduling gain by allocating a frequency resource to an area having a best channel status.

In particular, in case that a phase sequence is generated using a small cyclic delay in applying the phase shift based precoding or the generalized phase shift diversity, a flat fading channel can convert to a frequency selectivity channel to have a channel fluctuation. That is, there can exist a channel size increased part and a channel size deceased part in the frequency selectivity channel converted from a flat fading channel. Hence, a part of subcarrier area of an OFDM symbol increases in channel size, while another part of subcarrier area of the OFDM symbol decreases in channel size.

Referring to the right lower part of FIG. 9, a transmitter is able to obtain frequency diversity effect by assigning a user terminal to a part to have a good channel status due to an increased channel strength on a frequency band fluctuating in accordance with a relatively small cyclic delay value. In doing so, in order to apply a uniformly increasing or decreasing cyclic delay value to each antenna, a phase shift based precoding matrix can be used.

In this case, in an OFDMA (orthogonal frequency division multiple access) system accommodating a plurality of users, if a per-user signal is transmitted via a part of frequency band having an increased channel size, a SNR (signal to noise ration) can be raised. And, it frequently happens that a frequency band having an increased channel size differs per a user. So, in an aspect of a system, a multi-user diversity scheduling gain can be obtained. Moreover, since a receiving side simply transmits CQI (channel quality indicator) information of a part enabling each resource allocation of the frequency band for feedback information only, it is advantageous that feedback information is relatively reduced.

### Third Embodiment

### Time-Variable Type Generalized Phase Shift Diversity

In the GPSD shown in Formula 13, a phase angle (θᵢ) and a unitary matrix (U) can be changed in accordance with time variation. The time-variable type GPSD can be represented as follows.

$${GPSD}_{{N}_{t} \times R}^{k} ( t ) = ( \begin{matrix}{e}^{{jθ}_{1} ( t ) k} & 0 & ⋯ & 0 \\ 0 & {e}^{{jθ}_{2} ( t ) k} & ⋯ & 0 \\ ⋮ & ⋮ & ⋱ & 0 \\ 0 & 0 & 0 & {e}^{{jθ}_{{N}_{t}} ( t ) k}\end{matrix} ) ( {U}_{{N}_{t} \times R} ( t ) ) \qquad [ Formula 18 a ]$$

In Formula 18a, GPSD_{N}_{ₜ}^{k}×R^{(t)} indicates a GPSD matrix for a k^{th} subcarrier of an MIMO-OFDM signal having Nₜ transmitting antennas with a spatial multiplexing rate R at a specific time t. And, the first matrix at the right of an equal sign ‘=’ is a diagonal matrix for phase shift, and the second matrix at the right of an equal sign ‘=’ is a unitary matrix which spreads data symbols of each codeword in spatial domain and it should satisfy the unitary condition as

$${𝕌}_{{N}_{t} \times R}^{H} \times {𝕌}_{{N}_{t} \times R} = {𝕀}_{R \times R}$$

in order not to hurt open-loop channel capacity. In this case, ‘k’ can be a subcarrier index, an index assigned per a unitary resource in accordance with a situation, or index information allocated per a frequency band including at least one subcarrier.

Formula 18b indicates a result in obtaining a transmission signal by multiplying a data stream vector having a spatial multiplexing rate R by the GPSD matrix shown in Formula 18a.

$$y ( t ) = ( \begin{matrix}{e}^{{jθ}_{1} ( t ) k} & 0 & ⋯ & 0 \\ 0 & {e}^{{jθ}_{2} ( t ) k} & ⋯ & 0 \\ ⋮ & ⋮ & ⋱ & 0 \\ 0 & 0 & 0 & {e}^{{jθ}_{{N}_{t}} ( t ) k}\end{matrix} ) ( {U}_{{N}_{t} \times R} ( t ) ) x ( t ) \qquad [ Formula 18 b ]$$

In Formula 18b, x(t) indicates the data stream vector having the spatial multiplexing rate R and y(t) indicates a transmission signal vector.

In Formula 18a and Formula 18b, a phase angle θᵢ(t) (i=1, . . . , Nₜ) can result in Formula 19 in accordance with a delay value τᵢ(t) (i=1, . . . , Nₜ).

$${θ}_{i} ( t ) = - 2 π / {N}_{fft} \cdot {τ}_{i} ( t ) \qquad [ Formula 19 ]$$

In this case, N_{fft} indicates a number of subcarriers of an OFDM signal.

Referring to Formula 18 and Formula 19, a time delay sample value or a unitary matrix can vary in accordance with time. In this case, a unit of time can be an OFDM symbol unit or a time of a predetermined unit.

Examples of GPSD matrix, which uses 2×2 or 4×4 Walsh code as an unitary matrix to obtain a time-variable type GPSD, are summarized as follows.

TABLE 6
2 Tx

| Rate 1 | Rate 2 |
|---|---|
| $[ \begin{matrix}1 \\ {e}^{j {θ}_{{1}^{( t ) k}}}\end{matrix} ]$ | $[ \begin{matrix}1 & 1 \\ {e}^{j {θ}_{{1}^{( t ) k}}} & - {e}^{j {θ}_{{1}^{( t ) k}}}\end{matrix} ]$ |

TABLE 7
4 Tx

| Rate 1 | Rate 2 | Rate 4 |
|---|---|---|
| $[ \begin{matrix}1 \\ {e}^{j {θ}_{{1}^{( t ) k}}} \\ {e}^{j {θ}_{{2}^{( t ) k}}} \\ {e}^{j {θ}_{{3}^{( t ) k}}}\end{matrix} ]$ | $[ \begin{matrix}1 & 1 \\ {e}^{j {θ}_{{1}^{( t ) k}}} & - {e}^{j {θ}_{{1}^{( t ) k}}} \\ {e}^{j {θ}_{{2}^{( t ) k}}} & - {e}^{j {θ}_{{2}^{( t ) k}}} \\ {e}^{j {θ}_{{3}^{( t ) k}}} & - {e}^{j {θ}_{{3}^{( t ) k}}}\end{matrix} ]$ | $[ \begin{matrix}1 & 1 & 1 & 1 \\ {e}^{j {θ}_{{1}^{( t ) k}}} & - {e}^{j {θ}_{{1}^{( t ) k}}} & {e}^{j {θ}_{{1}^{( t ) k}}} & - {e}^{j {θ}_{{1}^{( t ) k}}} \\ {e}^{j {θ}_{{2}^{( t ) k}}} & {e}^{j {θ}_{{2}^{( t ) k}}} & - {e}^{j {θ}_{{2}^{( t ) k}}} & - {e}^{j {θ}_{{2}^{( t ) k}}} \\ {e}^{j {θ}_{{3}^{( t ) k}}} & - {e}^{j {θ}_{{3}^{( t ) k}}} & - {e}^{j {θ}_{{3}^{( t ) k}}} & {e}^{j {θ}_{{3}^{( t ) k}}}\end{matrix} ]$ |

### Fourth Embodiment

### Generalized Cyclic Delay Diversity

Since the phase shift based precoding and the generalized phase shift diversity according to the first to third embodiments, as shown in FIG. 5, are used on a frequency domain, a phase shift based precoding matrix or a generalized phase shift diversity matrix should be multiplied for each unitary resource or frequency band. So, a design of a transmitting side tends to be complicated. And, a receiving has to detect a signal by generating an equivalent channel from calculating the above matrixes in accordance with a delay sample each time after estimation of a multi-antenna channel, thereby having a complicated structure as well.

Hence, the present embodiment is characterized in simplifying transmitter and receiver designs in a manner of implementing the phase shift based precoding and the generalized phase shift diversity of the first to third embodiments on a time domain. This scheme shall be called generalized cyclic delay diversity (hereinafter abbreviated GCDD).

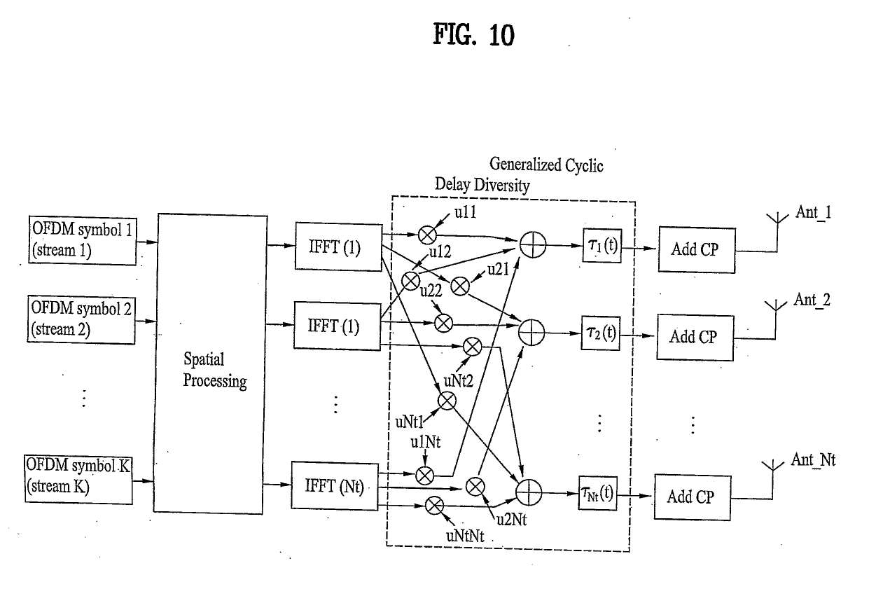

FIG. 10 is a conceptional diagram of a transmitter and receiver supporting GCDD.

Referring to FIG. 10, inverse discrete Fourier transform is applied to a signal, which has undergone spatial processing, per antenna. Before the signal is transmitted via the respective antennas, a complex weight is applied to the signal on a time domain. Cyclic delay is carried out on the corresponding signal in accordance with a cyclic delay sample value per the antenna. In FIG. 10, the complex weight is represented as ‘uij’. And, the ‘uij’ means a complex weight by which a j^{th} IFFT output signal transmitted via an i^{th} antenna is multiplied. FIG. 10 specifically shows GCDD corresponding to the time-variable type GPSD of the third embodiment.

Referring to FIG. 10, each of the IFFT output signals is independently multiplied by a complex weight and then transmitted via the one or more antennas. In other words, each transmission stream on a time domain is multiplied by a different complex weight per the antenna and the transmitted through the one or more antennas.

In order to apply a complex weight to an IFFT output signal, the above-explained unitary matrix can be used. In this case, it can be expected that a power of the signal transmitted via each of the transmitting antennas can be evenly distributed. For instance, when a number of transmitting antennas is 4, if the 4×4 Walsh code is used as a precoding matrix, a complex weight per an antenna can be 1 or −1.

### Fifth Embodiment

### Modification of Generalized Cyclic Delay Diversity

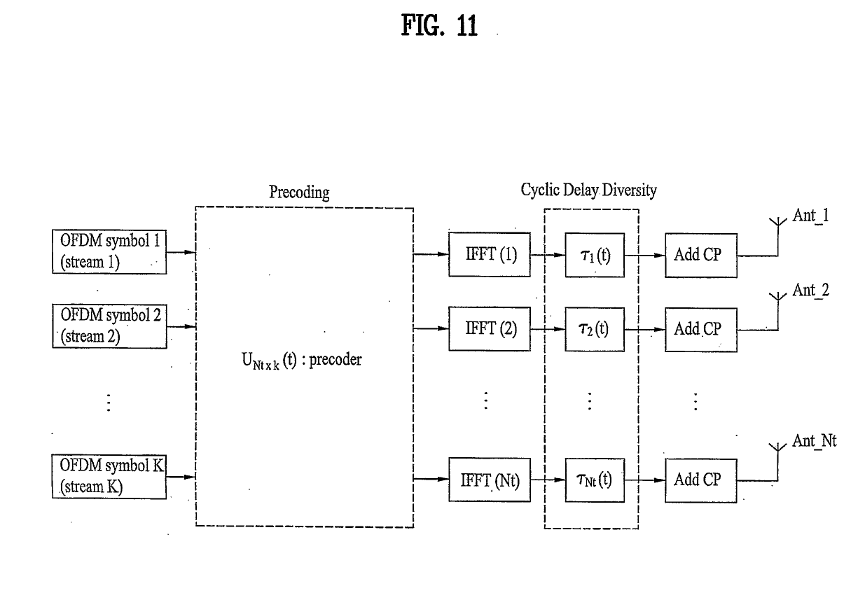

FIG. 11 is a conceptional diagram of a transmitter and receiver supporting a modification of GCDD scheme.

In the GCDD scheme of the fourth embodiment, a complex weight and a cyclic delay are applied after IFFT. Yet, in the present embodiment, as shown in FIG. 11, a complex weight is applied to a frequency domain prior to IFFT using a precoding scheme and a cyclic delay is applied to a time domain after IFFT using the related art cyclic delay diversity scheme. In this case, a cyclic delay value can be changed in accordance of lapse of time.

In FIG. 11,

$${𝕌}_{{N}_{t} \times K} ( t )$$

indicates a random precoding matrix having Nₜ rows and K columns at a specific time t. Preferably, it will be a precoding matrix having features of a unitary matrix. In this case, Nₜ indicates a value corresponding to a number of transmitting antennas and K indicates a value corresponding to a number of OFDM symbols by which a precoding matrix is multiplied, i.e., to a number of OFDM symbols inputted to a precoder.

### Sixth Embodiment

### Combination of GPSD and GCDD

In the present embodiment, by combining GCDD on a time domain and GPSD on a frequency domain together, complexity of a transmitter/receiver is lowered. And, it can be combined with a multi-antenna scheme having an arbitrary structure. In case that different frequency resources are allocated to a plurality of users having different channels respectively, a delay sample and multi-antenna scheme optimal for each user is applicable in a manner of applying an additional multi-antenna scheme or a different cyclic delay sample value in accordance with a user channel.

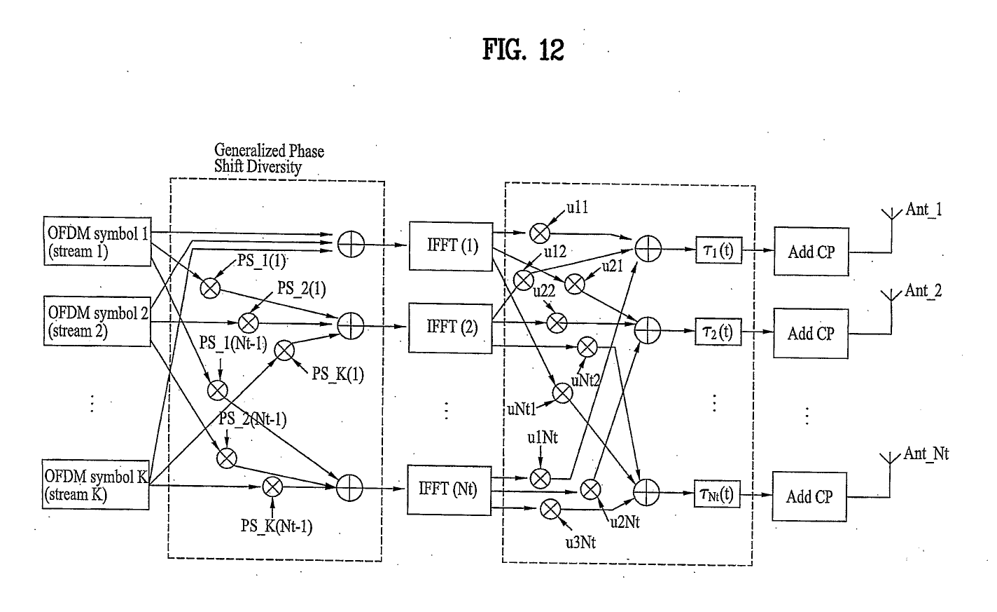

FIG. 12 is a conceptional diagram of a transmitter and receiver applied with a combination of GPSD and GCDD.

Referring to FIG. 12, PS_i(j) indicates a phase shift sequence by which an i^{th} OFDM symbol transmitted via (j−1)^{th} antenna is multiplied. ‘uij’ indicates a complex weigh by which a j^{th} IFFT output signal transmitted via an i^{th} antenna is multiplied. And, ‘τᵢ(t)’ indicates a cyclic delay value applied to a signal transmitted via an i^{th} antenna at a time t. A cyclic delay on a frequency domain can be implemented through a phase shift sequence of PS_i(j) and a cyclic delay on a time domain can be implemented through a cyclic delay value of τᵢ(t).

### Seventh Embodiment

### Modification of Combination of GPSD and GCDD

The combination of GPSD and GCDD of the sixth embodiment is modified in a manner of applying a cyclic delay on a time domain and applying a process except a cyclic delay on a frequency domain as precoding. Hence, a structure of a transmitting end can be more simplified.

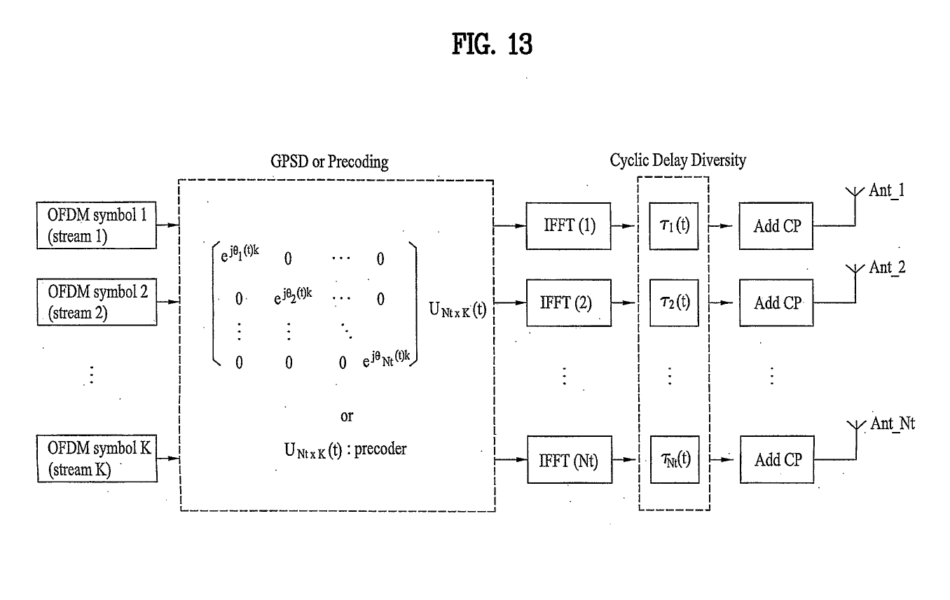

FIG. 13 is a conceptional diagram of a transmitter and receiver applied with a Modification of combination of GPSD and GCDD.

Referring to FIG. 13, GPSD or precoding a plied to all users prior to IFFT. In this case, a precoder for precoding may be a fixed one or fed back from a receiving end. And, a precoder, each phase value for phase shift and a delay sample value can vary in accordance with lapse of time.

The present embodiment is applicable to all kinds of multi-antenna schemes having the precoder structure. And, GPSD is usable per a user in accordance with a different frequency band. GPSD and precoding are applicable by being exclusive from each other or can be simultaneously applicable by being combined together.

In the sixth and seventh embodiments, GPSD and GCDD are combined together to use. Hence, a gain of a cyclic delay applied on a frequency domain and a gain of a cyclic delay applied on a time domain can be obtained together. By considering that an obtainable gain differs in accordance with a delayed size of a cyclic delay, more efficient resource use is possible.

For instance, as mentioned in the foregoing description, in case that a large delay value is applied, a frequency diversity gain can be obtained. In case that a small delay value is applied, a frequency scheduling gain can be obtained. So, it is able to raise a frequency use rate by selectively applying a large delay value on a frequency domain per a frequency or a frequency group. By applying a small delay value on a time domain, it is able to perform frequency scheduling on a transmission signal.

In other words, in case that a different frequency domain is allocated in accordance with a user, a small-size delay sample is applied to all user frequency bands using basic GCDD and a delay value for a specific user is applied to a specific frequency domain. Hence, a frequency scheduling gain and a frequency diversity gain can be simultaneously obtained.

### Eighth Embodiment

### Pilot Symbol Application Example 1

Various pilot symbols for channel estimation are applicable to the schemes of the above-explained embodiments.

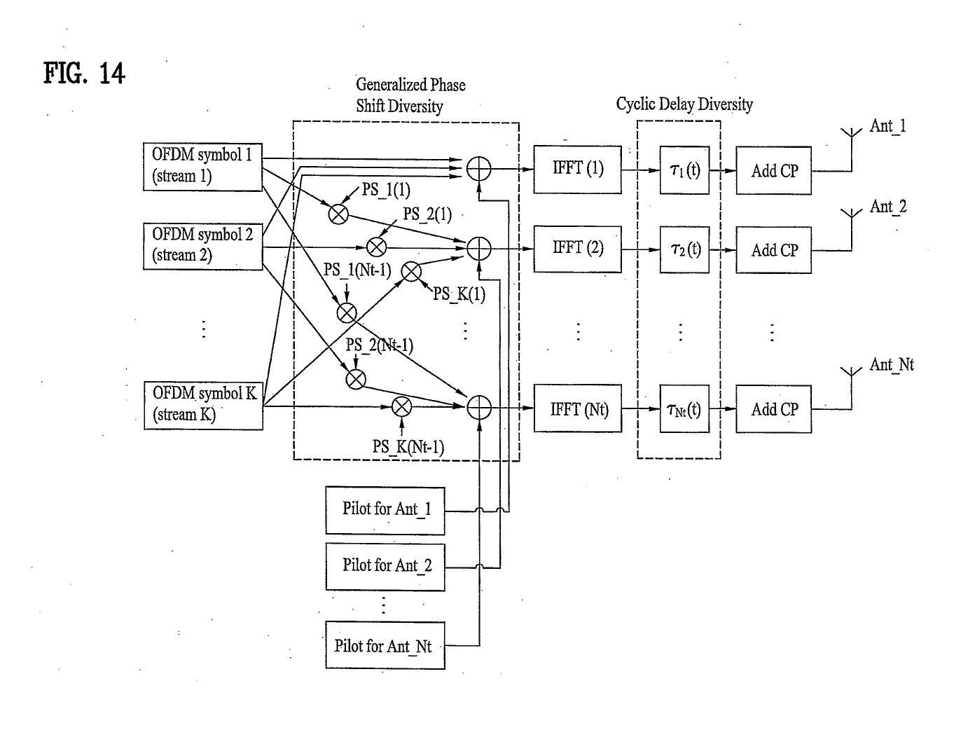

FIG. 14 shows a case that a pilot symbol by is added prior to IFFT in the GPSD scheme applied system.

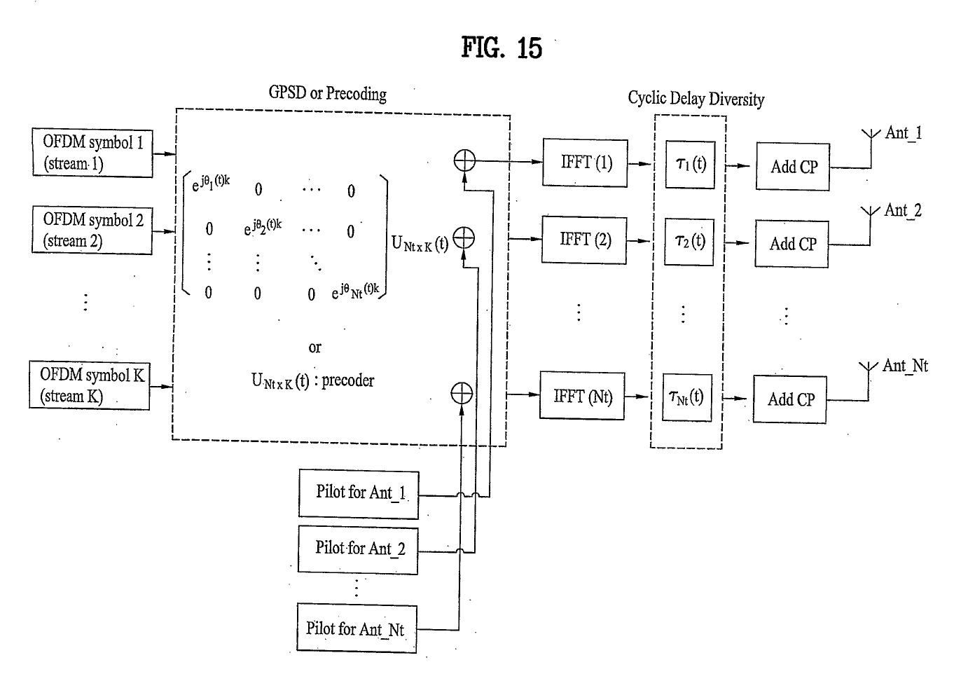

FIG. 15 shows a case that a pilot symbol by is added prior to IFFT in the GPSD or precoding scheme applied system.

In this case, since a pilot symbol is affected by cyclic delay diversity together with an OFDM symbol, a receiving end is provided with a channel estimation for GPSD and an equivalent channel only without being separately provided with a channel estimating circuit for a pilot symbol. So, it is advantageous in that complexity of a receiving end is reduced. A pilot transmitted in this manner is called a dedicated pilot.

Yet, embodiments associated with a pilot symbol, which is explained in the following description, are not limited to the seventh embodiment only. They are applicable to the first to seventh embodiments and all kinds of schemes that can be apparently modified from the first to seventh embodiments.

### Ninth Embodiment

### Pilot Symbol Application Example 2

FIG. 16 shows a case that a pilot symbol is added after cyclic delay diversity in the GPSD scheme applied system.

FIG. 15 shows a case that a pilot symbol is added after cyclic delay diversity in the GPSD or precoding scheme applied system.

In this case, since a receiving end receives a pilot symbol to which cyclic delay diversity is not applied, a channel estimating circuit for a pilot symbol has to be separately provided. So, compared to the eighth embodiment, the ninth embodiment has complexity increased more or less. Yet, a pilot symbol is not affected by a phase shift and channel estimation is for a real channel. Hence, it is advantageous that performance in channel estimation is enhanced. The pilot transmitted in this manner is called a common pilot.

### Tenth Embodiment

### Pilot Symbol Application Example

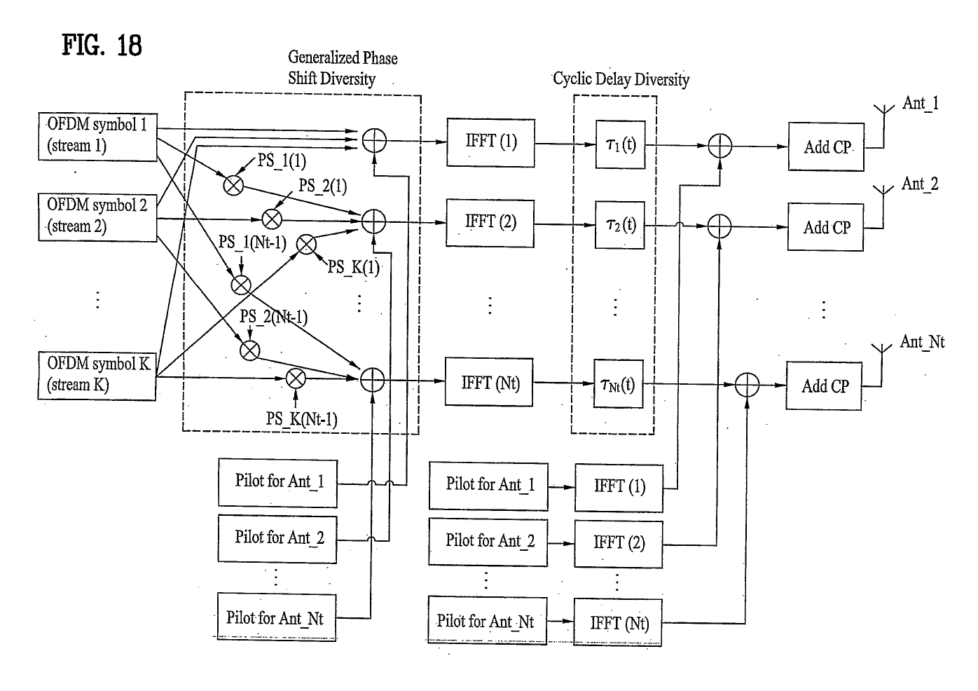

FIG. 18 is a diagram for a case that at least one pilot symbol is added both prior to IFFT and after cyclic delay diversity in the GPSD scheme applied system. Namely, it means that both a pilot symbol to which cyclic delay diversity on a time domain is applied and a pilot symbol to which cyclic delay diversity on a time domain is not applied are usable.

For instance, it is assumed that a cyclic delay diversity scheme having a large delay is applied on a frequency domain and it is also assumed that a cyclic delay diversity scheme having a small delay is applied on a time domain. In this case, a receiving end is made to obtain an equivalent channel having cyclic delay diversity applied thereto for a small-delay cyclic delay diversity scheme using a pilot symbol applied prior to IFFT and the receiving end is also made to obtain a real channel using a pilot symbol applied after cyclic delay diversity. Hence, it is able to expect that complexity of the receiving end can be reduced without degrading performance in channel estimation.

Although FIG. 18 shows the example that a pilot symbol is transmitted by discriminating a presence or non-presence of cyclic delay diversity application on a time domain only, it is able to apply the same pilot symbol applying method to cyclic delay diversity on a frequency domain as well. Namely, it means that a pilot symbol can be added before cyclic delay diversity on a frequency domain is carried out. In this case, diversity on a time domain will be applied to a pilot symbol as well as diversity on a frequency domain. Like the above-explained example, in case that a large-delay cyclic delay is used for cyclic delay diversity on a frequency domain, a receiving end is made to obtain an equivalent channel having a large-delay cyclic delay diversity applied thereto through a pilot symbol to which both the frequency-domain diversity and the time-domain diversity are applied.

Above-explained pilot symbol adding schemes can be applied in case of transmitting both of the dedicated pilot and the common pilot simultaneously, and than, the following effects can be obtained.

First of all, in case that an information size of a dedicated pilot is greater than that of a common pilot, a receiving end is able to estimate which a transmission delay value for a specific channel is for optimal performance. Hence, the receiving end estimates a transmission delay value for optimal performance and then feeds back the estimated vale to a transmitting end, whereby transmission efficiency can be enhanced.

Secondly, in case that an information size of a common pilot is greater than that of a dedicated pilot, a receiving end can measure a transmission delay between transmitting end and receiving end by comparing result of channel estimation using a common pilot and result of channel estimation using a dedicated pilot. Thereby, since the transmitting end needs not to inform the receiving end of a transmission delay value between the transmitting end and the receiving end, transmission efficiency within finite resources can be raised.

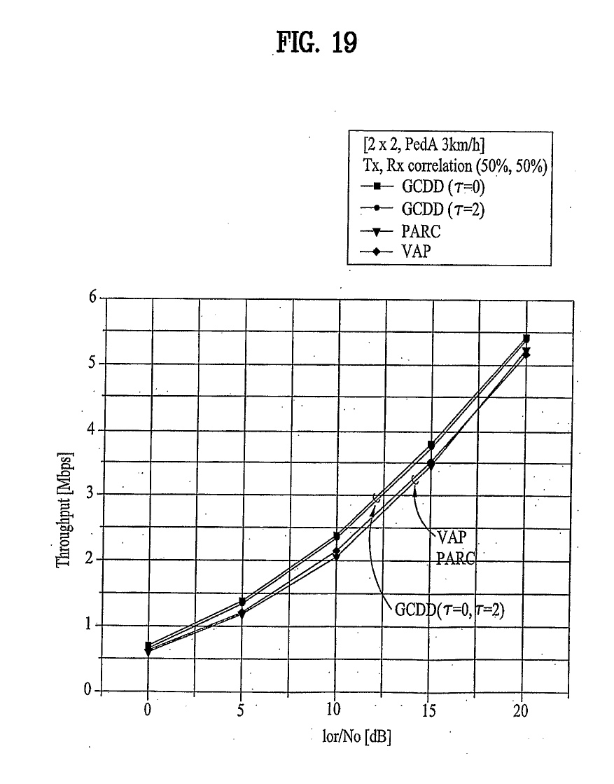

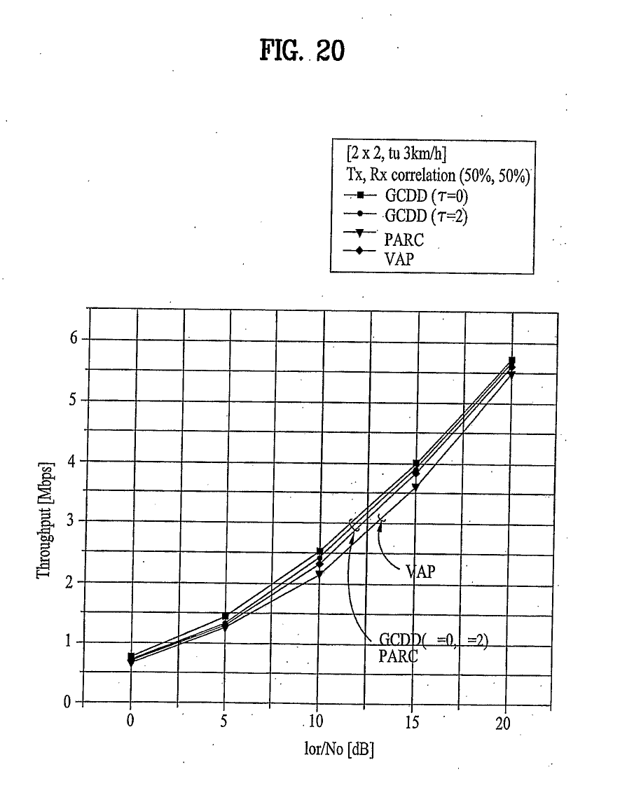

Link throughput performance of the GCDD system of the fourth embodiment is compared to that of such a related art system as PARC (per-antenna rate control) or VAP (virtual antenna permutation) as follows. Performance of a system shown in FIG. 19 and FIG. 20 according to the present invention corresponds to a test result of the case with system parameters shown in Table 8.

TABLE 8

| Parameter | Assumption |
|---|---|
| OFDM parameters | 5 MHz (300 + 1 subcarriers) |
| Subframe length | 0.5 ms |
| Resource block size | 75 subcarriers * 5 OFDM |
| | symbol |
| Channel Models | ITU Pedestrian A, Typical |
| | Urban (6-ray) |
| Mobile Speed (km/h) | 3 |
| Modulation schemes and | QPSK (R = ⅓, ½, ¾) |
| channel coding rates | 16-QAM (R = ½, ⅝, ¾) |
| | 64-QAM (R = ⅗, ⅔, ¾, |
| | ⅚) |
| Channel Code | Turbo code Component |
| | decoder: max-log-MAP |
| MIMO mode | SU-MIMO |
| Resource allocation | Localized mode |
| Codeword | MCW |
| Antenna configuration | 2 × 2 |
| Antenna selection option | 2 antenna groups (1 bit ASI) |
| Spatial correlation (Tx, | (50%, 50%) |
| Rx) | |
| MIMO receiver | MMSE receiver |
| CQI update period | 3 TTIs |
| CQI option | Full CQI |
| Channel Estimation | Perfect channel estimation |
| H-ARQ | Bit-level chase combining |
| | # of Maximum |
| | Retransmission: 3 |
| | # of Retransmission delay: |
| | 6 TTIs |

FIG. 19 is a graph of a simulation test result for a GCDD system and a related art system on ITU pedestrian-A channel, and FIG. 20 is a graph of a simulation test result in Typical urban (6-ray) environment.

Referring to FIG. 19 and FIG. 20, it can be observed that a high performance gain can be obtained from embodiments of the present invention applied in MIMO-OFDM system using GCDD scheme.

### Eleventh Embodiment

### Precoding Matrix for Transmission Power Allocation

After spatial processing has been carried out on OFDM symbol or data stream, the processed symbol or stream is multiplied by a precoding matrix for transmission power allocation before or after execution of IFFT per an antenna symbol. Hence, a transmission power for each transmitting antenna can be adjusted.

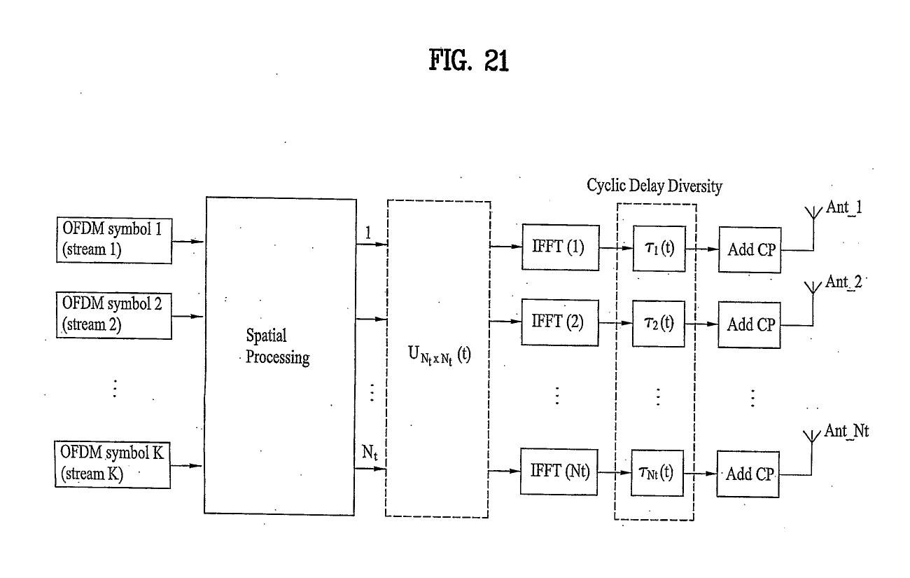

FIG. 21 is an exemplary block diagram of a transmitter and receiver for applying a transmission power allocation precoding matrix according to an embodiment of the present invention.

Referring to FIG. 21, a precoding matrix for transmission power allocation is applied for example in case that a cyclic delay is applied on a time domain.

After spatial processing has been carried out on OFDM symbol or data stream, transmission power allocation precoding matrix processing is executed. After the symbol or stream has been multiplied by a transmission power allocation precoding matrix, IFFT and signal processing for cyclic delay are carried out per a transmission antenna signal. The corresponding signal is then transmitted to a receiving end via a corresponding transmitting antenna.

In particular, a case of using a Nₜ×Nₜ unitary matrix as a transmission power allocation precoding matrix is explained as follows. Regarding a unitary matrix, as mentioned in the foregoing description, a unitary matrix should satisfy a power restriction for enabling a size of each column configuring the unitary matrix to be set to 1. Due to the feature of the power restriction, transmission powers for the respective transmitting antennas can be averaged.

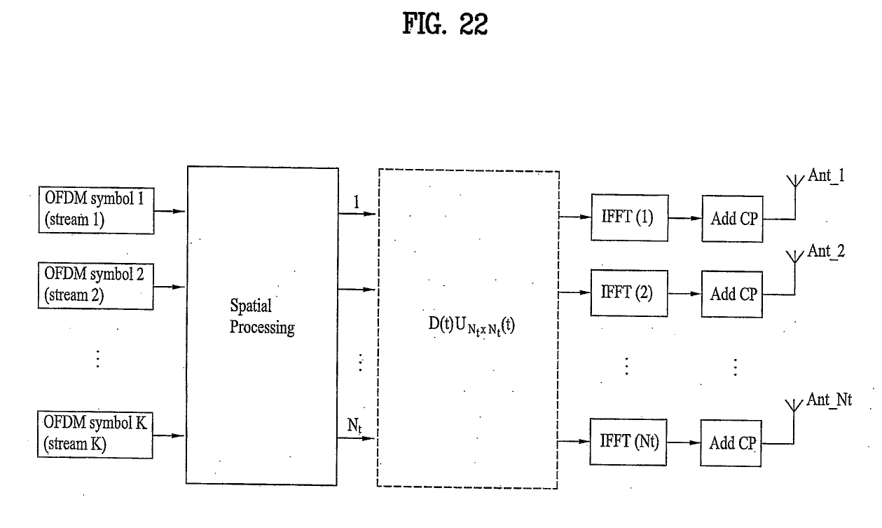

FIG. 22 is an exemplary block diagram of a transmitter and receiver for applying a transmission power allocation precoding matrix according to an embodiment of the present invention.

Referring to FIG. 22, in case that cyclic delay diversity is applied on a frequency domain, an example of applying a transmission power allocation precoding matrix is observed. The present embodiment can be explained based on a case of applying a phase shift based precoding matrix as well.

After spatial processing has been carried out on OFDM symbol or data stream, a phase shift matrix for cyclic delay diversity and a precoding matrix for transmission power allocation are processed. The symbol or stream is multiplied by the transmission power allocation precoding matrix, signal processing for IFFT is carried out per a transmitting antenna signal, and the processed signal is then transmitted to a receiving end via a corresponding transmitting antenna.

Various kinds of the phase shift matrix embodiments are available. Specifically, the phase shift matrix proposed as one element of the aforesaid GPSD matrix. Formula 20 shows a phase shift matrix proposed as one element of GPSD matrix.

$$D ( t ) = ( \begin{matrix}{e}^{{jθ}_{1} ( t ) k} & 0 & ⋯ & 0 \\ 0 & {e}^{{jθ}_{2} ( t ) k} & ⋯ & 0 \\ ⋮ & ⋮ & ⋱ & 0 \\ 0 & 0 & 0 & {e}^{{jθ}_{{N}_{t}} ( t ) k}\end{matrix} ) \qquad [ Formula 20 ]$$

In Formula 20, k indicates a subcarrier index, an index assigned per a unitary resource in accordance with a situation, or index information assigned per a frequency band including at least one subcarrier in accordance with a situation. And, D(t) is variably usable for a time (t) or fixed to use. By multiplying a diagonal matrix shown in Formula 20 in a transmitting end, cyclic delay is applicable per a transmitting antenna on a frequency domain.

A formation of combining the phase shift matrix of Formula 20 and the aforesaid transmission power allocation precoding matrix is shown in Formula 21.

$$D ( t ) {U}_{{N}_{t} \times {N}_{t}} ( t ) = ( \begin{matrix}{e}^{{jθ}_{1} ( t ) k} & 0 & ⋯ & 0 \\ 0 & {e}^{{jθ}_{2} ( t ) k} & ⋯ & 0 \\ ⋮ & ⋮ & ⋱ & 0 \\ 0 & 0 & 0 & {e}^{{jθ}_{{N}_{t}} ( t ) k}\end{matrix} ) {U}_{{N}_{t} \times {N}_{t}} ( t ) \qquad [ Formula 21 ]$$

In Formula 21, it can be confirmed that a formation is similar to that of the GPSD matrix. Yet, in the present embodiment, since it is assumed that a signal, on which spatial processing is carried out, is multiplied by the precoding matrix of Formula 21, the GPSD matrix differs from a unitary matrix in size. Namely, Nₜ×Nₜ unitary matrix is used for the present embodiment, whereas Nₜ×R unitary matrix is used for the GPSD matrix.

In other words, no matter what kind of spatial processing is used, the present embodiment enables transmission power allocation by a unitary matrix regardless of the spatial processing. In this case, phase shift or cyclic delay is applicable.

As mentioned in the foregoing description, D(t) or U_{N}_{ₜ}_{×N}_{ₜ}(t) is variably usable or fixed to use in accordance with a time (t).

To obtain a transmission signal y(t) using the matrix formula shown in Formula 21, an output value of a spatial processing unit can have one of various forms in accordance with a spatial processing scheme. If an output value of a spatial processing unit is a vector c(t) having a length Nₜ, a transmission signal y(t) can be represented as Formula 22.

$$y ( t ) = ( \begin{matrix}{e}^{{jθ}_{1} ( t ) k} & 0 & ⋯ & 0 \\ 0 & {e}^{{jθ}_{2} ( t ) k} & ⋯ & 0 \\ ⋮ & ⋮ & ⋱ & 0 \\ 0 & 0 & 0 & {e}^{{jθ}_{{N}_{t}} ( t ) k}\end{matrix} ) {U}_{{N}_{t} \times {N}_{t}} ( t ) \cdot c ( t ) \qquad [ Formula 22 ]$$

In Formula 22, D(t), U_{N}_{ₜ}_{×N}_{ₜ}(t) or C(t) is variably usable or fixed to use in accordance with a time (t).

In formulas 20 to 22, a phase angle θᵢ(t) (i=1, . . . , Nₜ) can be represented as Formula 23 in accordance with a delay value τᵢ(t) (i=1, . . . , Nₜ).

$${θ}_{i} ( t ) = - 2 π / {N}_{fft} \cdot {τ}_{i} ( t ) \qquad [ Formula 23 ]$$

In this case, N_{fft} indicates a number of subcarriers of an OFDM signal.

Referring to Formulas 20 to 23, a time delay sample value or a unitary matrix can vary in accordance with lapse of time. In this case, a unit of time can be an OFDM symbol unit or a time of a predetermined unit.

By averaging a transmission power transmitted from each transmitting antenna via a transmission power allocation precoding matrix, it is able to balance a transmission power of a power amplifier per a antenna of a transmitter. In case that the present embodiment is used together with phase shift or time delay diversity scheme, it is expected that a problem of transmitting a transmission signal in a specific direction only can be solved.

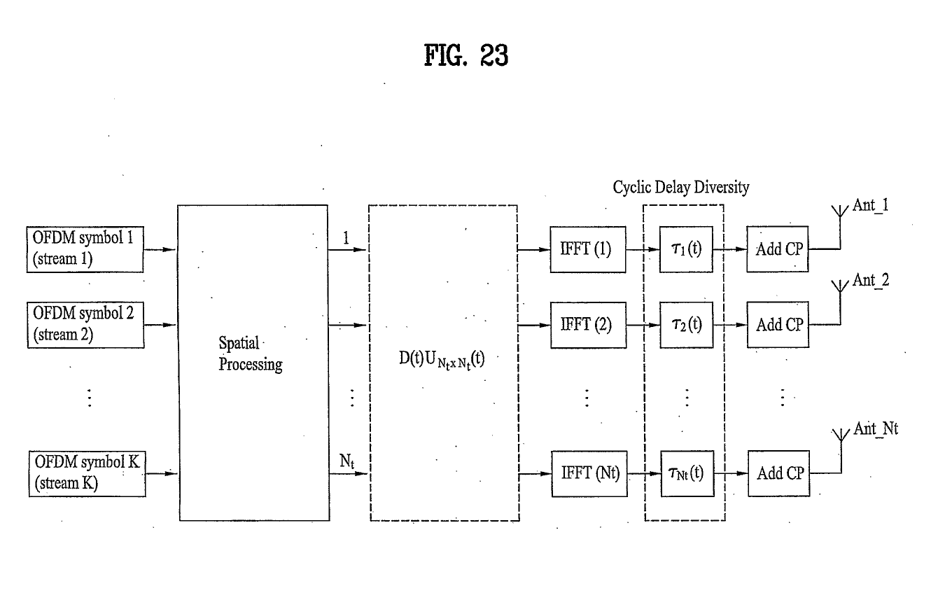

FIG. 23 is an exemplary block diagram of a transmitter and receiver for applying a transmission power allocation precoding matrix according to an embodiment of the present invention.

Referring to FIG. 23, in case that cyclic delay diversity is applied on a time domain and a frequency domain, an example of applying a precoding matrix for transmission power allocation can be observed. Namely, a combination of the embodiments shown in FIG. 21 and FIG. 22 can be observed.

Thus, if cyclic delay diversity is applied on a time domain and a frequency domain, like the aforesaid embodiment for the combination of GPSD and GCDD, both a gain of cyclic delay applied on a frequency domain and a gain of cyclic delay applied on a time domain can be obtained together.

Moreover, considering that a gain obtainable in accordance with a delay size of cyclic delay differs like the case of applying a large cyclic delay on a frequency domain or a small cyclic delay on a time domain, resources can be more efficiently used.

Examples for applying a pilot symbol by a transmitter/receiver according to the present invention are explained as follows.

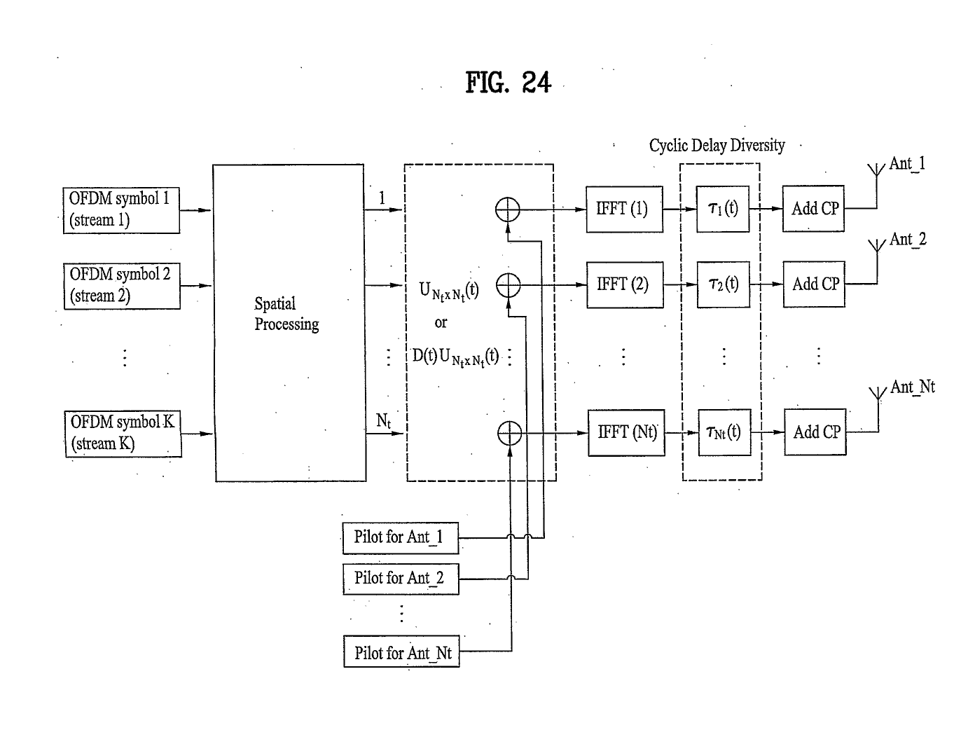

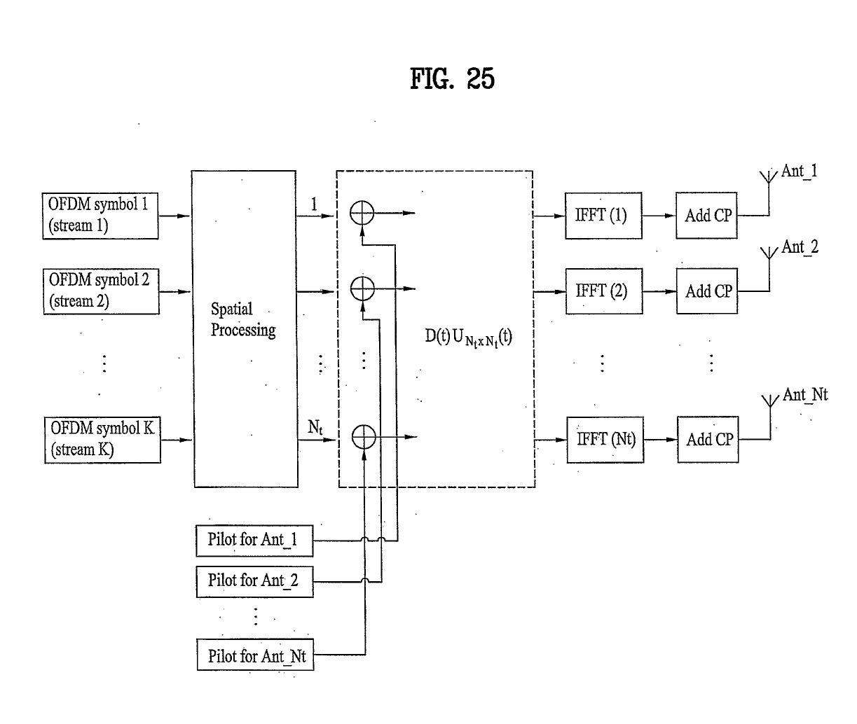

FIG. 24 is an exemplary block diagram of a transmitter and receiver for applying a pilot symbol to the embodiment shown in FIG. 21 or FIG. 23, and FIG. 25 is an exemplary block diagram of a transmitter and receiver for applying a pilot symbol to the embodiment shown in FIG. 22.

Referring to FIG. 24 and FIG. 25, a pilot symbol is applied prior to execution of IFFT. So, it is able to use cyclic delay diversity, which is executed per an antenna after IFFT processing, for a pilot symbol.

In this case, since the pilot symbol is affected by cyclic delay diversity together with OFDM symbol, a receiving end is just provided with a channel estimation for GPSD and an equivalent channel without being provided with a channel estimating circuit for a pilot symbol in addition.

Hence, it is advantageous that complexity of the receiving end is reduced.

In other words, in a manner of using phase shift or time delay for a pilot symbol equally, it is able to solve the problem that complexity is additionally increased in a receiver.

Yet, under the circumstances, since phase shift or time delay is not used for a pilot symbol, a receiver is enabled to estimate a channel to which a phase shift or time delay diversity scheme is not applied.

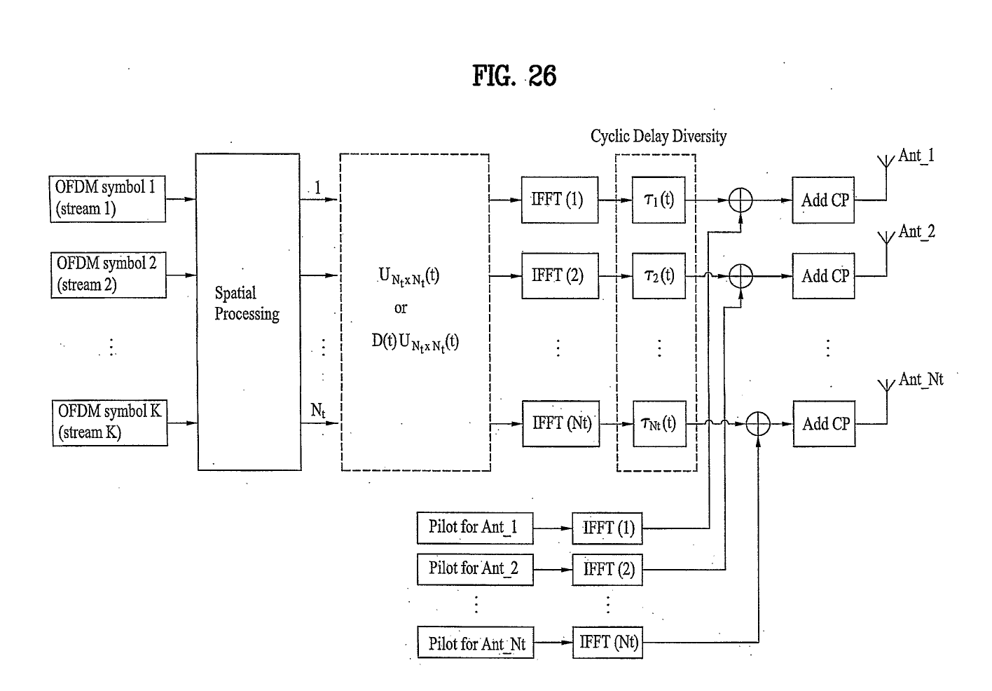

FIG. 26 is an exemplary block diagram of a transmitter and receiver for applying a pilot symbol to the embodiment shown in FIG. 21 or FIG. 23.

Referring to FIG. 26, a pilot symbol is applied after IFFT has been executed as well as cyclic delay diversity. So, cyclic delay diversity, which is executed per an antenna after separate IFFT processing, is not applied to a pilot symbol.

In this case, since a pilot symbol, to which cyclic delay diversity is not applied, is received by a receiving end, a channel estimating circuit for a pilot symbol needs to be separately provided. Compared to the embodiment of applying cyclic delay diversity to a pilot symbol, this embodiment has complexity that is increased more or less. Yet, channel estimation for a real channel is carried out while a pilot symbol is not affected by cyclic delay diversity, i.e., phase shift. Hence, it is advantageous that performance in channel estimation is enhanced.

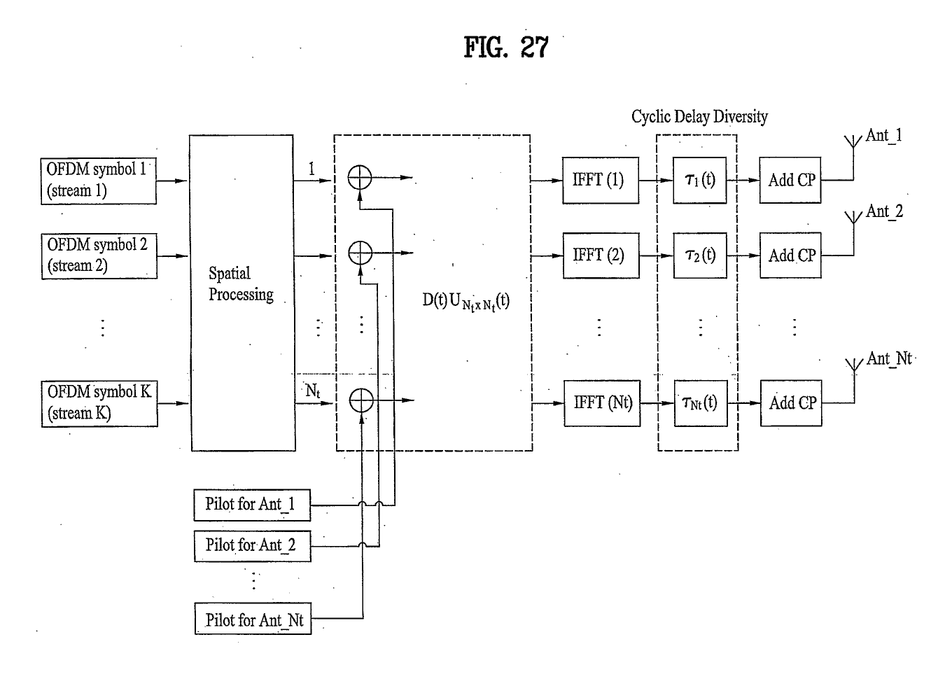

FIG. 27 is an exemplary block diagram of a transmitter and receiver for applying a pilot symbol to the embodiment shown in FIG. 23.

Referring to FIG. 27, a pilot symbol is applied before cyclic delay, i.e., phase shift is executed on a frequency domain. Hence, cyclic delay diversity on a frequency domain is applied to a pilot symbol as well as cyclic delay diversity executed on time domain per an antenna after completion of IFFT processing.

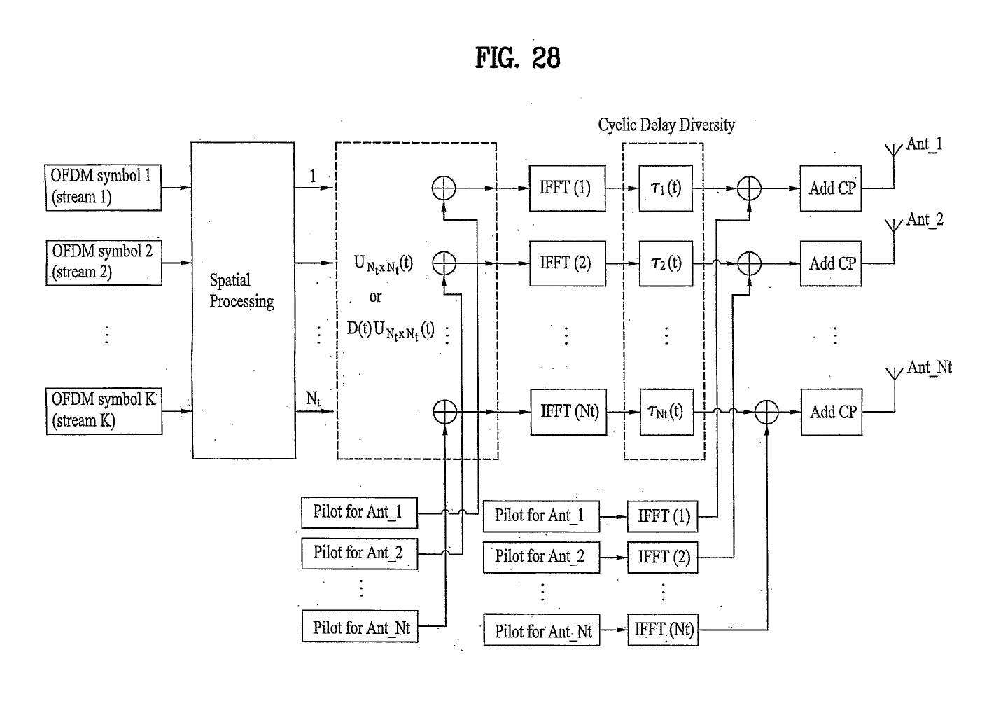

FIG. 28 is an exemplary block diagram of a transmitter and receiver for applying a pilot symbol to the embodiment shown in FIG. 21 or FIG. 23.

Referring to FIG. 28, a pilot symbol for each antenna is applied at least twice. In particular, a pilot symbol such as a pilot symbol applied prior to execution of IFFT and a pilot symbol applied after completion of cyclic delay diversity execution on a time domain is applied at least twice.

Thus, by transmitting both a pilot symbol having cyclic delay diversity applied thereto and a pilot symbol having cyclic delay diversity not applied thereto to a receiving end, it is able to obtain real channel information having cyclic delay diversity not applied thereto as well as an equivalent channel having cyclic delay diversity applied thereto.

And, it is apparent that a pilot symbol, to which both cyclic delay diversity on a frequency domain and cyclic delay diversity on a time domain are applied, is applicable together with or regardless of the aforesaid symbol application examples.

### INDUSTRIAL APPLICABILITY

Accordingly, a phase shift based precoding scheme of the present invention is able to adaptively cope with a channel status or a system status regardless of an antenna configuration or a spatial multiplexing rate while maintaining the advantages provided by the related art phase shift diversity or precoding scheme.

Moreover, by selectively adopting time-dependent phase variation and cyclic delay scheme and the like to a phase shift based precoding scheme, complexity of a transmitter/receiver is enhanced and combination with every multi-antenna scheme is available.

Besides, the present invention is applicable by varying a communication condition per a user, thereby obtaining optimal communication performance.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A method of transmitting signal in MIMO (multiple-input multiple-output)-OFDM (orthogonal frequency division multiplexing) system, the method comprising:
spatial processing an OFDM symbol corresponding to each of the subcarriers on a frequency domain with considering time variable element;
transforming the spatial processed OFDM symbol into a transmission signal on a time domain; and
transmitting the transmission signal.

2. The method of claim 1, further comprising adding a first pilot symbol corresponding to each antenna to the spatial-processed OFDM signal.

3. The method of claim 1, further comprising at least one of multiplying the transmission signal by a plurality of per-antenna weight; and applying a prescribed cyclic delay to the transmission signal.

4. A method of transmitting signal in MIMO (multiple-input multiple-output)-OFDM (orthogonal frequency division multiplexing) system, the method comprising:
performing precoding on OFDM symbols respectively corresponding to a plurality of the subcarriers on a frequency domain;
transforming the precoded OFDM symbols into per-antenna signals on a time domain;
applying a prescribed cyclic delay to each of the per-antenna signals; and
transmitting the per-antenna signals.

5. The method of claim 4, further comprising adding a first pilot symbol corresponding to each antenna to each of the precoded OFDM symbols.

6. The method of claim 4, further comprising adding a second pilot symbol transformed into the time domain to each of the cyclic-delayed per-antenna signals.

7. A method of transmitting signal in MIMO (multiple-input multiple-output)-OFDM (orthogonal frequency division multiplexing) system, the method comprising:
determining a phase shift based precoding matrix by multiplying a first matrix for a phase shift by a second matrix for transforming the first matrix into a unitary matrix;
phase shift based precoding by multiplying OFDM symbols by the determined phase shift based precoding matrix corresponding to each of a plurality of the subcarriers;
transforming the phase shift based precoded OFDM symbols into transmission signals on a time domain;
applying a prescribed cyclic delay to each of the transmission signals; and
transmitting the cyclic delayed transmission signals.

8. The method of claim 7, further comprising multiplying each of the transmission signals by a plurality of per-antenna weight.

9. The method of claim 8, further comprising adding a first pilot symbol corresponding to each antenna to each of the phase shift based precoded OFDM signals.

10. The method of claim 7, further comprising adding a second pilot symbol transformed into the time domain to each of the cyclic-delayed transmission signals.

11. The method of claim 7, wherein the phase shift based precoding matrix is represented as
$$( \begin{matrix}{e}^{{jθ}_{1} ( t ) k} & 0 & 0 & 0 \\ 0 & {e}^{{jθ}_{2} ( t ) k} & 0 & 0 \\ 0 & 0 & ⋱ & 0 \\ 0 & 0 & 0 & {e}^{{jθ}_{{N}_{t}} ( t ) k}\end{matrix} ) ( {U}_{{N}_{t} \times R} ( t ) )$$
and wherein a phase angle θᵢ(t) (i=1, . . . , Nₜ) of the first matrix or the second matrix is a time variable element.

12. A method of transmitting signal in a multi-antenna system, comprising:
performing spatial processing associated with multi-antennas on each data stream to be transmitted via at least one of the multi-antennas;
performing a transmission power allocation precoding on the spatial processed data stream to control transmission power for the multi-antennas;
transforming the transmission power allocation precoded data stream into a per-antenna signal on a time domain; and
transmitting the per-antenna signal via at least one of the multi-antennas.

13. The method of claim 12, further comprising at least one of:
applying phase shift diversity on the spatial processed data stream; and
applying cyclic delay diversity on the per-antenna signal.

14. The method of claim 13, wherein the phase shift diversity applies a large cyclic delay value and wherein the cyclic delay diversity applies a small cyclic delay value.

15. The method of claim 12, further comprising at least one of:
adding a first pilot symbol to the spatial processed data stream;
adding a second pilot symbol to the transmission power allocation precoded data stream; and
adding a third pilot symbol transformed into the time domain to the per-antenna signal.

16. The method of claim 12, wherein the transmission power allocation precoding is executed by multiplying a Nₜ×Nₜ unitary matrix (Nₜ is a number of the multi-antennas).

17. The method of claim 16, wherein the Nₜ×Nₜ unitary matrix is multiplied by a diagonal matrix with a phase value as a variable.

18. The method of claim 12, wherein at least one of the Nₜ×Nₜ unitary and the diagonal matrix is a time variable element.

19. The method of claim 2, further comprising at least one of multiplying the transmission signal by a plurality of per-antenna weight; and applying a prescribed cyclic delay to the transmission signal.

20. The method of claim 16, wherein at least one of the Nₜ×Nₜ unitary and the diagonal matrix is a time variable element.
